(19) United States
(12) Patent Application Publication
(10) Pub. No.: US 2005/0027645 A1
(43) Pub. Date: Feb. 3, 2005

(54) Business enterprise risk model and method

(76) Inventors: William, Wai, Shing Lui, Cortlandt Manor, NY (US); Wai-Keung Tang, Putnam Valley, NY (US); Hung Jung Lu, Stamford, CT (US)

Correspondence Address: John B Hardaway III;Nexsen Pruet Adams Kleemeier, P O Box 10107, Greenville, SC, 29603, US

(21) Appl. No.: 10/502,901

(22) PCT Filed: Jan. 31, 2003
(86) PCT No.: PCT/US03/02879

(30) Foreign Application Priority Data
Jan. 31, 2002 (US) 60353566

(51) Int. Cl. G06F 17/60

(52) U.S. Cl. 705/38

(57) ABSTRACT

A method for evaluating the risk associated with an enterprise is presented. The method, based on a value-at-risk approach, uses a large number of scenarios to simulate the potential variation in the enterprise's future surplus capital based on its current assets and liabilities, and produces a probability distribution of future surplus capital. The scenarios are generated using quasi-Monte Carlo techniques in order to quickly achieve realistic scenarios. Each asset and each type of liability is modeled rigorously, and the effect of credit, interest rate, insurance, currency exchange, and equity risks on those assets and liabilities determined. The model also allocates surplus capital by division according to the risk associated with each division. The model is particularly well-suited for insurance companies.

### BACKGROUND OF THE INVENTION

The business of an insurance company is to assume the risks of individuals in exchange for a fee. In order to be able to assume these risks at reasonable cost and make a profit, the insurance company relies on understanding the probabilities of the occurrence of various insured events and on insuring large numbers of individual insurance policy holders to diversify risk. Each policyholder merely has to pay the fee charged by the insurance company, that is, the premium, but none of them needs to reserve the finds that would be needed to cover the financial impact of the event. The insurance company needs to determine how much to charge for providing insurance and to reserve, after expenses, to pay for the costs of loss that are reasonable likely to occur. It will also invest the accumulating funds from the premiums it collects.

It is fundamental that the insurance company must have a clear understanding of the probabilities that the events it insures against will occur and how often. Moreover, because certain events do in fact occur from time to time, it is equally important that insurance companies provide for those events by reserving sufficient funds in advance to cover the costs associated with those events. Because time may pass until some of those funds are needed, insurance premiums can be invested. Insurance companies are exposed to risks stemming from insurance underwriting and investment. Therefore, an important aspect of proper management of an insurance company is management of risk, both in determining the nature and extent of risks to assume and in assuring that sufficient funds from both received premiums and investment income is on hand when needed. In order to assure a high probability of solvency in the future, insurance companies are required by regulators to maintain certain equity capital. In theory, the more risk a company is exposed to, the more equity capital is required to maintain a high probability of solvency in the future.

Pricing insurance products is traditionally the main function of actuaries. Actuaries calculate the probabilities that insurable events might occur, the severity of the loss and determine premiums based on those probabilities. After the premium is collected, actuaries also establish an appropriate level of reserve, which is the predicted sum of the future payments on insurance losses. Actuaries also monitor and reevaluate periodically the adequacy of reserves. However, the actuaries of an insurance company are less concerned with how wrong they might be; in other words, they have historically not been concerned with the risk that their probabilities might turn out to be wrong.

An insurance company will also have an internal investment department or may elect to contract for the services of an external asset management firm to invest the premium income from the policyholders so that sufficient funds can be available to cover the costs of the risks that the insurance company is exposed to. Investment managers are usually concerned only with the investment risk and can take advantages in advances in investment risk analysis in assessing investment risk. Consequently, risks from insurance underwriting and from investment are usually managed separately and therefore the holistic risk, or the “enterprise risk,” of an insurance company is not known.

However, with the past few decades, with certain events occurring such as the interest rate spikes of the 1980s, natural disasters and the equity “bubble” of the late 1990s, there has been an increasing concern with downside of expectations and cash flow testing. Life insurance companies are now required to issue an Actuary Opinion Memo following testing of their cash flow under either different interest rate scenarios.

Value-at-Risk (VaR) is the dominant method in risk management throughout the global financial services industry. This method was first adopted by large investment banks, and was quickly embraced by virtually all global financial institutions to manage financial risks. The American and international regulators have also embraced VaR methods and are in the process of adopting it a part of the regulatory process.

Commercial banks borrow funds from depositors and lend them out at a higher rate. Therefore, commercial banks are very interested in the credit risk inherent its portfolio. However, the rates for their loans are private and there are no public trading data that a bank can used to evaluate its VaR. As a result, some banks use internal or external credit rating systems to price the prospective loans based on historical default experience. When the economy is not growing, banks will suffer more on credit loss. Two examples of recent and significant credit loss crises for American banks are the Saving and Loan crisis and the Third World Debt crisis. Both crises could have wiped out the banking system in the United States.

Commercial banks are also exposed to interest rate risk. Since banks borrow short term (most deposits can be withdraw on short notice) and lend long term (most loans cannot be recalled on short notice), banks will suffer large losses if interest rates change unexpectedly. For example, in the early 80's, when interest rates increased up to 20%, a lot of banks had made long term non-cancelable loans at much lower rates. As a result, banks had to pay a higher cost to attract funds than what they got for the funds. This type of risk is generally known as interest rate risk.

Although some banks incorporate the credit risk of their loan portfolios with the rest of its risk, most banks use a credit rating system to price loans without considering other risks the banks are exposed to.

Investment banks earn their profit from underwriting securities, from brokerage and consulting, and from trading. Investment banks are exposed to business risk because they maintain infrastructures to provide securities underwriting, brokerage, and consulting. When business climate is poor, they will suffer loss due to their high fixed costs.

Many investment banks hold the securities they underwrote for resale. Therefore investments banks are exposed to credit risk when they underwrite securities. Since investment banks trade on their own accounts, they are exposed to many different kinds of risk. Based on the unique risk profile of each bank, a bank can do well in any economic climate, or it can do poorly.

For an investment bank to compete in trading, it must maintain a strong risk management function. The bank must be able to price an individual risk and to evaluate the enterprise risk correctly. If a bank does not understand its enterprise risk, it will not fully understand its decision to take risk. Therefore investment banks have the most sophisticated technology for VaR.

Mutual funds are exposed to risk arising out of the asset they invest in. Although mutual funds are not directly exposed to the profit or loss of their investments, their own fees and therefore profits are certainly related to the performance of their funds.

Pension funds have specific obligations of providing for the retirees in their plans. On top of the normal investment risk, there are predictable cash outflow patterns that pension fund managers have to work with.

Most non-financial corporations maintain portfolios of short-term investment in many currencies to service their cash flow needs. Many non-financial corporations also maintain books of commodity trading. For example, oil and energy companies usually trade oil and energy commodities. Agriculture product companies trade agriculture commodities. Metal companies trade metal commodities. VaR is an important tool for them to use to analyze their risk exposure.

Understanding risk is of critical importance to an insurance company, as well as many of these other enterprises. It is not surprising, then, that other attempts have been made to quantify risk. These attempts focus on the risk associated with assets alone or liabilities alone, rather than with assets and liabilities together. For many years, “VaR” was used by banks as a way of assessing their asset risk. This approach looked at the value of assets that were at risk today or other short term horizon, permitting simplifying assumptions that allowed the model to be easily used by conventional computers. However, the traditional VaR approach does not work well for insurance companies, which have a longer horizon. Insurance companies have longer horizons because they usually do not trade their assets actively, a lot of their assets are held until maturity.

Eventually, the VaR concept was supplanted by a different approach, namely, “dynamic financial analysis.” In dynamic financial analysis, the analyst attempts to determine the value of a portfolio of assets as it changes from decisions made in response to changing conditions. For example, if the value of a stock drops by a pre-designated amount, the stock is sold and the proceeds invested in a different asset, such as a bond issue. Dynamic financial analysis is intended to simulate reality by providing for decisions that are likely to be made in response to changing conditions. However, it requires considerable programming and run time. The outputs of dynamic financial analysis are heavily determined by the decision rules as well as taxation strategy and accounting rules that are programmed into the analysis. Many believe that dynamic financial analysis is a better tool to test the effectiveness of the decision rules than the riskiness of an existing business profile.

Thus there remains a need for a better way to model the risk of an enterprise and an insurance company in particular.

### SUMMARY OF THE INVENTION

The present invention is an enterprise-wide risk model. The model looks at the risks to the enterprise's assets and liabilities that are associated with the current strategy of an enterprise. These risks include equity risk, credit risk, currency exchange risk, insurance risk and interest rate risk. Risk associated with operations can be included as an option. Although based on an approach analogous to the VaR approach, the present model is different in many respects. For example, it looks at the impact in the future on net worth from current strategies. It quantifies the enterprise's risk assuming that a given strategy is in place for a given amount of time, preferably one year. The results of the application of the present model show the distribution in value of the surplus capital one year from today based on the continuation of today's strategy. The distribution of capital surplus combines both assets and liabilities. In the case of an enterprise that is an insurance company, the liabilities include insurance policies.

While the mean of the distribution of capital surplus of an enterprise may be an interesting number, the shape of the distribution carries more information. Therefore, a useful risk score is the surplus divided by the standard deviation to obtain the capital adequacy ratio. Also, the probabilities of default and of the loss of a significant percent of income are more significant numbers than the standard deviation, and are useful when comparing different enterprises.

This model combines the risk associated with both assets and liabilities to give a total picture of the enterprise's risk. The risks associated with different enterprises can be compared in order to sort or rank various enterprises by risk. A manager can test various strategies to see which have the best return for the lowest risk. The manager can use the present tool to provide input for pricing insurance policies at a level that assures adequate reserves, can match assets with liabilities, and can evaluate different strategies. The present model will calculate the probability of insolvency given the existing operations and investment portfolio. A manager can achieve a desired level of insolvency probability by changing the equity capital, the investment strategy or business operating strategy. The present model not only can look at the risk of a single enterprise but at combined risk of several enterprises and at the risk of a division within an enterprise. The present risk evaluation tool is thus highly useful in considering mergers, acquisitions and divestitures.

An important feature of the present invention is the merging of asset risk and liability risk. Prior art risk models based on the VaR method exist for assets but not for liabilities. Merging the two types of risk presents a complete picture of the enterprise's overall risk, avoiding the delusion that may come from seeing a low risk asset portfolio that does not cover a high-risk liabilities.

Another important feature of the present invention is the rigorousness of the modeling of each aspect of risk. Sometimes this rigor is found simply in capacity. For example, the model addresses currency exchange risk for 30 different currencies rather than just a few (or none at all). Sometimes it is found in “granularity,” that is, in the level of detail that is modeled, such as security issue rather than each security class. Rigorousness is also found in mathematical modeling that is based on careful analyses. Simplifying assumptions are made only after testing the validity of those assumptions mathematically. This is particularly true at the extreme ends of the probability distribution, where the errors of less rigorous treatments of asset and liability risks are magnified. As stated above, the probability of default, found at the end of the distribution, is more important than the mean cases, which are around the center of the distribution.

Still another important feature of the present invention is the speed at which the model when properly programmed runs. Results are available in minutes, compared to days for other types of programs.

The allocation of capital is still another important feature of the present invention. It is important for a company to understand the relative performance of all of its divisions in order to plan for future investment and divestiture. Financial performances are usually based on the annual return on the capital invested in each business division, which is commonly known as Return on Capital. Capital has to be allocated among the various divisions before Return on Capital can be calculated.

Now theoretically, equity capital is used to sustain unexpected shortfalls in funds. Therefore, the more risk a division contributes, the more likely it will need to tap into the equity capital and, in theory, the more equity capital it uses. Therefore capital is allocated among the divisions of an organization according to the risk they contribute to the overall enterprise risk. Thus, the risk of each division is calculated and capital apportioned accordingly. However, the sum of the risks of all divisions is larger than the enterprise risk because a significant portion of the risk is diversified away when one calculates the risk of all the divisions combined. This is so because all the divisions do not have a bad return at the same time. The present model will not only calculate the risk of a division by itself, but also the risk each contributes to the enterprise, net of the risk diversified away, which is a function of the risk characteristics of all the divisions of the enterprise.

Another feature of the present invention is that it is applicable to global enterprises. Currency risk and foreign assets, for example, are evaluated along with other risks and domestic assets.

The use of current market data, frequently updated, is another feature of the present invention. Current market data provides more accurate measures of risk and allows proper calculation of the correlations among different sources of risk.

Those skilled in financial analysis of enterprises will realize these and other features and their corresponding advantages from a careful reading of the Detailed Description of Preferred Embodiments, accompanied by the following drawings.

### BRIEF DESCRIPTION OF THE DRAWINGS

In the drawings,

FIG. 1 is a software flow chart of the present model, according to a preferred embodiment of the present invention.

### DETAILED DESCRIPTION OF PREFERRED EMBODIMENTS

The present invention is a method for risk analysis of an enterprise; the method is based on a mathematical model of the combined asset and liability risk associated with that enterprise. The model is implemented through a software program on a general-purpose computer. Although the model is illustrated in the context of an insurance company, it will be clear that the model may be adapted in a straightforward way to other types of enterprises, such as a pension fund, for example.

Risk is normally defined in two ways: uncertainty and chance of losing. Uncertainty can be measured in terms of standard deviations, or a certain transformation of the distribution, such as the Wang transformation. Based on the uncertainty of a company's value and its current financial strength, the present model also measures the downside risk—the probability of losing value. In general, the higher the standard deviation is, the greater the downside risk.

In particular, the uncertainty or standard deviation of concern is that associated with the surplus capital expected at some time in the future based on the combination of assets and liabilities in place today and that results from fluctuations in a number of risk-associated variables such as interest rates, currency exchange rates, and so on. If these variables have tended historically to fluctuate widely over time, then the impact of these variables on risk is greater. Those that have exhibited little movement have less impact on risk. For example, if the historical return on IBS tock is 30%, then the risk of holding $10 million in IBM stock is $3 million.

When more than one asset or liability is held, there can be a correlation between the two. Linear correlation, which is a common measure of correlation, ranging from negative one, implying that the two move in opposite directions, to zero, implying that the two move independently of each other, to a correlation of positive one, implying that the stocks move up and down together synchronously. In some real-life situations, extreme correlation is often higher than what the linear correlation indicates. In those cases, the parametric copula method is more appropriate than the linear correlation method to capture the correlation between the two. Holding two assets or liabilities with lower correlation reduces risk to capital, as a result of a greater diversification benefit to their owner, than when the correlation is high or nearly one.

In order to calculate the risk to an enterprise, all assets and liabilities that create uncertainty in the enterprise's future net worth need to be identified. The risk exposure of each of these needs to be measured. The correlations among these must be estimated, and then the total net risk can be calculated. The total net risk is subtracted from the total of the individual risks to obtain the diversification benefits. In the present model, traditional value-at-risk (VaR) methods of estimating risk and determining correlations and diversification benefits are extended to include the estimation and correlation of credit risk to other risks and to the inclusion of liability risk. The present method looks at the surplus distribution farther out, preferably one year, and it models the extreme ends of the surplus distribution more rigorously, painting a truer picture of the probability of default. It also allocates capital in accordance with the allocation of risk.

While the value-at-risk (VaR) method has traditionally been applied to managing asset risk, the present model applies the VaR method to analyze risk related to the liability of some organizations. When property and casualty insurance companies accept insurance premiums, they accept an uncertain liability to pay if the insured events occur. When life and health insurance companies accept premiums, they, too, accept an uncertain liability to pay if the insured dies or get sick. Pension funds also have liability risk if there is uncertainty in their future cash outflow. Even hedge funds and mutual funds have liability risk because they cannot predict precisely the future cash inflow and outflow of their funds. The present model uses the VaR method to calculate the liability of different enterprises and incorporates the liability with its asset risk to calculate total, net enterprise risk.

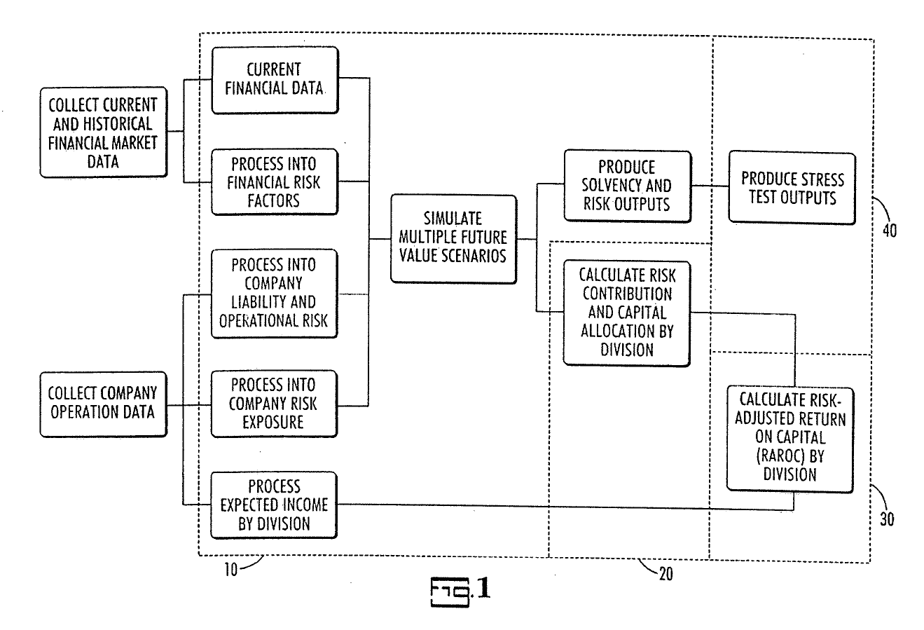

FIG. 1 shows a flow chart depicting an overview of the present method. Beginning on the left side of the chart, current and historical financial market data is collected and stored in a database. This data is also processed in financial risk factors as described below. Company operational data is also collected and processed to extract enterprise liability and operational risk and enterprise risk exposure. The expected income by “segment,” or division is produced from the operational data.

Next a large number, preferably at least 1000 and most preferably about 10,000, of future value scenarios are generated, and the current financial data, financial risk factors, liability and operation risk, risk exposure and division income are analyzed under these various scenarios to build a distribution of future surplus capital. From this distribution, the solvency and risk outputs can be extracted as well as the risk contribution and capital allocation by segment. The scenarios can also be adjusted to produce “stress test” outputs if desired, that is, to impose unusual or catastrophic risks on the enterprise. The risk adjusted return on capital for each division can be determined from each division's risk contribution and capital allocation.

The present model has four basic modules. These are a risk calculation engine 10, a capital allocation engine 20, a performance measurement engine 30 and a scenario-testing engine 40. Risk calculation engine 10 reads company risk profile data, risk factors, and the correlation matrix (or copula parameters) and performs the risk calculations. Capital allocation engine 20 measures the risk contribution of each division of the enterprise, allocates a portion of the diversification benefit to each division, and then allocates capital to the divisions based on their risk contributions. The use of this module is optional.

Performance measurement module 30 is also optional. Based on synthetic asset methodology, it allocates income to each division and calculates the risk-adjusted return on capital (RAROC) by division.

In scenario-testing module 40, new tests in addition to the basic testing can be included to investigate the enterprise's resilience to unusual risks such as catastrophes. Two types of “stress testing” can be performed. The first type of “stress testing” is to determine what the future net worth of the enterprise will be if certain events happen, such as a dramatic change in interest rates, an earthquake or windstorm happening, etc. The second type of “stress testing” is to determine the future risk profile if certain events happen, such as certain segments of the financial markets become more or less volatile. For example, the model will determine what a company's risk profile would be if the credit risk increases or the equity market becomes more volatile.

The enterprise risk model score measures the financial strength of an enterprise. This score is defined as the net worth divided by risk (in standard deviation or Wang transformation). If the probability distribution of the future surplus is normal, a score of three indicates a 0.1% chance of insolvency. A score of one indicates a 16% chance of insolvency. However, the probability distribution of surplus capital is rarely normal, therefore the downside risk has to be determined on a case-by-case basis.

The present model is based on the well-known value-at-risk (VaR) approach but with many important differences. Generally, there are three alternative approaches to determining VaR. The first is the “delta approximation” method, which uses the multiplication of matrices of assets and correlation factors. The distribution of net worth is unknown, but often assumed to be normal so that meaningful interpretation can be made. This approach is useful and valid for short horizons (less than 10 days, for example) and is not computationally intensive. This method calculates the standard deviations of an enterprise's future surplus or equity quickly. However, this method does not provide the insight about the probability distribution of the future surplus or equity. To estimate downside risk, e.g., chance of default or insolvency, one has to make assumptions concerning the underlying probability distribution of the future surplus or equity.

Another approach to determining VaR is based on historical simulation. This approach requires mathematical “boot strapping.” It draws randomly on historical data for a risk distribution. Its results are not stationary and it is not a good approach for capturing infrequent events such as bond default and catastrophic risks.

The third approach, and the one that is used in the present model, is the multivariate simulation method. In this method, multiple possible future scenarios are generated based on correlation relationships, or copula methodology. Then a distribution of capital surplus is generated from those scenarios from the net value of all the assets and liabilities of the enterprise. This type of approach is required for accuracy in longer-horizon analyses, and it requires significant computation capability. This method produces a detailed probability distribution of the future surplus capital, and from that, the present model can estimated downside risks without making assumptions on the net worth distribution.

Risks to an insurance enterprise fall into five basic categories: credit, interest rate, insurance, equity, and currency exchange risk. There are also operational risks but these are too subjective and infrequent to be captured by historical data. For example, if a new management team takes over a company, the operational risk is likely to change. The credit risk is associated with uncertainties in upgrades and downgrades in the asset rating, or with uncertainties in the default of the asset. Interest rate risk is associated with uncertainty in movements in interest rates in the future. Uncertainty in insurance liabilities gives rise to insurance risk. For example, if loss experience fluctuates significantly, insurance risk is greater. Exchange rate fluctuations give rise to exchange rate risks. Historical records of fluctuations in each of these risk categories are used to create probability distributions in each of these risk categories that are then used to predict future fluctuations in the capital surplus

Each of these five basic risks is expanded into perhaps 2500 or more separate categories. For example, the present model subdivides “currency risk” into 30 or more currencies. Equity risk is subdivided into hundreds of particular corporate issues both domestic and foreign. Insurance risk is subdivided into different types of insurance such as whole life, term life, etc.

Each asset and liability may correlate to some extent with every other asset and liability. How one asset or liability varies with any other can be extracted from historical data just as the fluctuations of the value of any one asset can be extracted. The correlation factors of these assets and liabilities are stored in a matrix as part of risk calculation engine 10. The correlation factors are updated periodically, such as every three months, with new financial data.

In the present model, data about the assets and liabilities of the enterprise are imported from the enterprise's databases and spreadsheets (see FIG. 1). This data is then transformed and entered into a financial database that can be read by the risk calculation engine 10. A large number of “scenarios” are then generated using a quasi-Monte Carlo method to simulate events over the coming year. These scenarios are a set of values for variables that affect the surplus capital of the enterprise. The values in each scenario are selected so that they are not unlikely to happen; the correlation matrix (or copula) data is used to impose rules on the possible range of values for each variable and quasi Monte Carlo techniques are applied to obtain the final set of scenarios quickly and efficiently.

The surplus capital of the enterprise is calculated for each scenario. The resulting large number of surplus capital results, one for each of the large number of scenarios, is then output as a probability distribution of future surplus capital.

The use of quasi-Monte Carlo methods for generating scenarios is a particular feature of the present invention. This method obtains convergence on each rule-limited scenario much faster, 10-100 times faster, than other methods for generating scenarios. It is a mainstream technique in financial and academic, particularly scientific circles. Importantly, it enables the enterprise risk to be determined in a very short period of time, much faster than in dynamic risk analyses, for example, and makes the present method a much more practical tool for a host of uses.

The use of a large number of scenarios to simulate future risk is a departure from the usual VaR approach, as described above. In the prior art versions of VaR, the distribution of net worth value was assumed to be normal. A linear approximation is suitable when the time horizon is short and the stock option exposure is not large. These assumptions are not accurate for insurance companies or other enterprises with a longer time horizon. Furthermore, the distribution of net worth for an insurance company is known to not be normal and the Taylor series expansion of the underlying risk factors' distributions requires second and higher terms in order to be accurate. However, rather than use the higher order terms of the Taylor series, the net worth distribution can be simulated using a larger number of scenarios. The combination of simulation and quasi Monte Carlo methods to generate the scenarios for the simulation is a feature of the present invention. This combination provides a high degree of accuracy without undue calculation delays

Scenarios are sets of values for the variables that affect net worth, which is the same as surplus capital. Surplus capital of, say, $500 million today will have a different value a year from today. But the future value, due to the effects of all the risk the company is exposed to, is uncertain. The future surplus capital can be very large or very small, but is most likely going to be in the area around $500 million. The present model simulates the behavior of the company and generates multiple possible scenarios each producing a future surplus. These scenarios represent a range of possible events that might occur over the next year that give rise to a different net worth one year from now. This type of uncertainty, a range of different surpluses, forms a probability distribution. The average of all the possible surplus capital values is called the mean, or the expected future surplus capital. Say, for example, the mean is $560 million. However, other values also have associated probabilities. The scenarios that give rise to all these values do not represent every possible event but are constrained by “real world” rules. Based on the empirical data from the financial markets and the company's own operating history and unique characteristics, the model develops correlation-based rules that govern the way the future surplus capital can behave. Rules limit the possible combinations of scenarios to those that could actually happen and not those that cannot happen.

The distribution resulting from the calculations of future surplus capital may be skewed depending on, for example, the types of insurance offered by the enterprise. So the value of the distribution's mean does not by itself provide full information about the risk of the enterprise. Several numbers can be extracted from the probability distribution that are perhaps more important to the user. The first is an enterprise risk score called the capital adequacy ratio, which is defined as the initial surplus divided by the standard deviation of the distribution. The second is a probability of losing a certain percentage of assets or dollars worth of assets. The third is the probability of default. These values can be output along with the distribution itself.

The calculation of surplus capital is actually done six times. The first time, all the basic five risk categories are included. It is then performed five more time, each of which is intended to isolate a separate risk category. In each of the subsequent five calculation sequences, only one of these five basic risk categories is included so that there is a distribution for each of the five types of risk (credit, interest rate, currency, etc.). 10,000 scenarios are used each time the calculation is performed although good results are obtained with as few as 1,000.

The probability distribution of surplus capital corresponding to each of these types of risks is determined along with the surplus capital distribution with all five, which shows the diversification benefit of the five. These are determined for all assets and all liabilities.

“Assets” include asset-based securities and mortgage-based securities, government bonds, municipal bonds, rated and unrated corporate bonds, rated and unrated preferred stocks, common stocks, derivatives such as caps, swaps and futures, residential and commercial mortgages, real estate holdings, collateralized and uncollateralized loans, reinsurance receivables and long term investments. The credit spread for each of these is the difference between the return at the horizon and that of government (risk free) assets.

In addition, the present model tracks 30 currencies, 10 industry sectors, seven credit ratings, 9 interest rate durations per currency, and all property and casualty and life insurance types. These allow each of the five broad types of risk to be further subdivided into 2500 or more sub-categories. For example, credit risk is divided by rating, by country and by industry sector. Interest rate is further subdivided by duration and country. Equity risk is subdivided by country and industry sector. Insurance risk is subdivided by country and by line of business. The risk and correlation factors are calculated for each risk factor subcategory.

Equity risk is determined as follows. It is estimated by the variance and covariance of the historical return on equity indices. It is assumed that each country has ten sectors (energy, financial, cyclical, etc.).

Some assets are much more difficult, such as those that are said to be highly structured, such as derivative and mortgage- and asset-based securities (MBS and ABS, respectively). The risk characteristics of each of these must be input by hand.

Some risk models, such as dynamic financial analysis group MBS and ABS into asset groups before calculating their risks. However, this approach is not accurate. This inaccuracy, in the case of insurance enterprises, is a significant problem since about half of the bond portfolios of insurance companies is made up of MBS and ABS.

Credit risk is based on a ratings transition matrix, which summarizes the historical pattern of migration for bond ratings. For example, a BBB bond may be upgraded or downgraded or defaulted with certain probabilities that are easily derived from historical data. Given the range of possible values and probability, the distribution of the future value of a BBB bond can be calculated.

Although the stand-alone credit risk can be calculated with historical default and downgrade history information, the determination of the correlation between credit risk and other risks is quite complicated. The default probability of a bond is a function of the stock performance of its issuer. Therefore, in generating the 10,000 scenarios, stock return by country and by sector is one of the variables. The default probability is then modeled as a function of sector stock return and the company's own specific risk (the larger the company's asset size, the smaller the specific risk).

In the instances of non-public assets, the historical rates for default of non-rated bonds, private loans and mortgages can be used to determine a default rate. Then, by comparison to the default rates of rated bonds, a rating can be assigned to the otherwise unrated asset.

Currency risk, the risk of holding assets or liabilities in foreign currency, is determined from historical currency exchange rates

Interest rate risk is manifested in the variance and covariance of interest rates of different maturities. These rates can be obtained from historical data, but a good proxy for a one-year interest rate is a money market instrument with a one-year maturity. These rates will vary country to country.

Interest rate risk is determined by the cash flow matching method. In particular, expected cash inflow from all assets and the cash outflow from all expected claim payouts is calculated. The difference between inflow and outflow is the net cash flow by year. The net yearly cash flow is then multiplied by the maturity-dependent interest rate risks and the diversification benefit is netted out.

Changes in the interest rate affect various assets, such as bonds. The present model simulates a large number of scenarios, each with its own future interest rate yield curve. If bonds are present in an asset portfolio, the impact of their value will be affected based on generated yield curves. Each bond is analyzed given its individual characteristics, rather than after grouping them by type. Callable bonds are analyzed as a straight bond minus the call option, and the call option values are calculated for each of the scenarios.

Insurance risk of property and casualty insurance companies is composed of premium risk and reserve risk. Premium risk is the risk associated with the uncertainty of the initial loss ratios. Premium risk can be classified as new business risk. This uncertainty can be determined from historical records. For example, if the uncertainty of the initial loss ratio in a particular type of insurance, such as homeowners' insurance, over a period of time is 8%, this means that for every dollar of premium written in homeowners' insurance, $0.08 of uncertainty will be created in the enterprise's net worth.

There are also correlations among different types of insurance, such as between automobile insurance and health insurance for example. Historical information from the enterprise and the insurance industry provides these correlations. The lower the correlation among different lines of insurance carried by an enterprise, the greater the diversification benefit. The present model applies the enterprise's specific uncertainty of the premium of each line of insurance it offers to determine the risks before the diversification can be determined and applied.

There is risk associated with reserves which is a function of the age of the policy and the experience of the year in which it was written. Reserve risk is broken down into one-year reserve risk and “ultimate” reserve risk. Reserve risk can be classified as old business risk. The former results from the uncertainty of reserve development one year from now and is a measure of future accounting surplus. The ultimate reserve risk results from the uncertainty of reserve development until all losses are paid and is a measure of future economic value. These risks, in terms of uncertainty, can be determined from historical company records: what was the uncertainty in reserves for a new policy written in year 1995? In 1996? What was the uncertainty in reserves for a one-year-old policy written in year 1995? In 1996? The total one-year reserve risk is determined by consolidating the first year reserve risks for all years: the current reserve for each year is multiplied by the uncertainties by policy age to obtain a “stand alone” risk (i.e., before diversification). The diversification benefits are subtracted to give the net risk. Each line of insurance is handled the same way, and then the total risk from each line is summed to obtain the total risk before diversification.

For example, to determine if the US dollar/Singapore dollar exchange rate and the credit risk of an AAA rated bond move together, or the extent to which they do, historical data of the two are put together and the covariance is calculated.

On the liability side, different enterprises have different liability risks. Insurance companies collect premiums for use in compensating future losses. Insurance companies estimate the value of the future losses and set up insurance reserves to cover those future losses. A future loss is a form of liability that affects capital surplus: the higher the reserve, the lower the surplus capital. Some liabilities are newly acquired from new business; others were acquired some time ago from business acquired some time ago, but the insurance company still retains responsibility to pay future losses. The present model separates the liability risk of insurance companies into two classes: those from new business and those from previous business. The liability risk of the new business is called the “new business risk,” which comes from the uncertainty of the loss ratio of new business the company is going to underwrite this coming year. The liability risk of the business of previous years is called “old business risk.” Although the reserves of that business were established before, insurance companies re-estimate future losses of old business from time to time. Therefore, given new information, the reserves for old business risk will change.

Historically, the loss ratio forms a distribution that represent the risk that the losses may be more or may be less in any given year. In the present model, two loss ratio distributions are used: one for old business risk, or existing reserves, and one for new business risk. The risk factors for each are calculated from both the industry data and company data.

The liability risks of property and casualty insurance companies and health insurance companies come from the uncertainties in the frequency of the occurrences of insured events, and, once the events occur, how severe the losses. These are commonly known as frequency risk and severity risk.

Liability of a life insurance company comes from the company's promise to pay out death benefits when its life insurance policyholders die, to pay out annuity benefits as longs as its annuity policyholders live, and to guarantee a minimum return to the policyholders' funds deposited with the company. Some liability risks of an insurance company come from mortality risk (the rest come from the misalignment of the company's investment strategy and its liabilities). Mortality risk is the uncertainty of the life span of the insured. A life insurance company's surplus capital will be lower than expected if its annuity policyholders live longer than expected. On the other hand, if the investment return the insurance company generates is lower than what the minimum return guaranteed, the amount of surplus capital would be lower than expected.

In determining mortality risk, the present model calculates how the surplus capital is affected by a gradual change in the mortality table. The mortality rates are affected by a drift term and a volatility term. All of these factors affect the cash flow pattern of the life insurance products and therefore the net present value.

The five basic categories of risk apply to life insurance products (whole life, term, life, etc.). Insurance risk can be further subdivided in to mortality risk—the impact on the enterprise's net worth due to the difference between the actual mortality experience and the expected mortality experience—and the morbidity risk—the impact on the enterprise's surplus capital due to the difference between the actual morbidity experience and the expected morbidity experience. Interest rate risk impacts the enterprise's surplus capital due to changes in the interest rate yield curve. Equity risk impacts surplus capital due to fluctuations in the equity market return. There can also be a business risk that impacts the enterprise's surplus capital due to changes in the business environment. Therefore each type of insurance product can have an impact on at least one of the five basic risk categories.

In the present model, each product segment is analyzed as if it were a fixed income security with financial options. The net present value of each insurance product will be affected by the mortality and morbidity rates, the interest rate yield curve, lapse and surrender rates, in-force value, premiums, the length of the policy and return guarantees. These factors may affect the cash flow pattern and the discount rate for the various insurance products and therefore, the net present value.

For example, mortality risks are inherent in life insurance and life annuity products. Morbidity risks are inherent in accident and health products. Each type of product is analyzed for the factors that affect it. These different products are then accurately modeled. In life insurance, mortality risks should be small if the enterprise has many independent cases in their portfolio of policies. Morbidity risks in health and dental insurance may be high but they are short-tailed and subject to repricing, so the actual insurance risk is small.

In analyzing the interest rate risk of insurance products as if it were a fixed income security with financial options attached, the well-known “cash flow matching” technique is used to determine net present value. In order to use this method, historical data regarding fluctuations of interest rates is obtained and the equivalent bond value is calculated from them. A good approximation for the one-year interest rate risk, for example, is a money market instrument with a one-year maturity.

The equity risk associated with insurance company products is generally non-existent. Insurance companies do not take equity market risks for their clients but some variable annuity products offer minimum return guarantees. These are analogous to a put option, and are sensitive to the current equity market performance. The future incomes of variable annuity products are also impacted by equity market performance. One may argue that this risk is akin to equity market risk, in the present model, it is categorized as business risk. Equity market risk is estimated using historical returns on equity, by country and by sector (cyclical, financial, service, energy, etc.). It is assumed that each country has ten sectors.

Business risk means that some risk to the future profit stream is associated with operational factors, such as the lapse and surrender rates, and the equity and bond market returns. Business risk is more subjective than the other risk factors because it requires a projection of the enterprise's future profitability. There are many other factors that affect business risk, too many, in fact to capture them all. Some types of business risks are modeled, as will be described below.

Each type of life insurance product has its own associated risk. Term life has interest rate risk because the cash inflow and outflow are mismatched. It also has mortality risk as a function of the in-force amount. The net present value of term life of policies of each segment (based on demographics) depends on four factors. The first of these four factors is the difference between the fixed premiums and expected death benefit. The second is the difference between 1 and the accumulated lapse rate. The third factor is the survival rate; and the forth is the discount factor. Zero profit is assumed because the volatility of future profit is a business risk.

Single premium life insurance also has interest rate and mortality risk. Its present value of all policies in a demographic segment depends on three factors: expected death benefit, survival rate and discount factor. Generally the interest rate risk of a single premium life insurance policy is greater than a term life policy.

Whole life insurance products have relatively little interest rate risk because the cash inflows and outflows are matched. (Whole life policies do have mortality risk, of course.) However, if the interest rates in the future are sufficiently low, insurance companies will suffer loss because the cash value will not pay for the death benefits. Generally, the cash value of a whole life policy is analyzed as if it were a fixed annuity.

A single premium life income annuity has interest rate and mortality risk. Its present value is equal to the total single premium less the sum over discounted cash outflows as dictated by policies in that demographic segment. The cash outflows depend on three factors: the fixed annual benefit, the annuity survival rate and the discount factor. A similar approach is taken to model other income annuities, such as those with term limits or deferred incomes.

A structured settlement has only interest rate risk and its net present value is easily calculated after the settlement payout pattern is known.

Accident and health insurance products have morbidity risks and some have interest rate risk when the premium is guaranteed for more than one year. For simplification, it is assumed in the present model that the risk is the same as a 20-year term life insurance product on a 40 year old.

Fixed annuities are savings products that have a floating rate of return but may have a minimum return guarantee, and are analogous for analysis purposes to a structured settlement. These have interest rate risk because of cash mismatch. The extent of the interest rate risk can be mitigated by an accumulation period and a liquidation period. These products are also similar to short-duration, floating rate bonds. When a minimum interest rate is guaranteed, the risk is defined as the change in the option value due to a change in interest rate. The calculation of the risk associated with fixed annuities is described below

A variable annuity is another savings product that provides a variable rate of return but often with minimum return guarantees, and are similar to equity put options. Risk comes from fluctuations in the value of the option and is classified as an interest rate and equity risks since equity put options are sensitive to both interest rates and equity market returns. The method of calculating the risk of an equity put option is described in detail below.

The present method also models how the lapse rate, which is one type of business risk, affects the enterprise's future surplus capital. The lapse rate can be based on historical data for each type of insurance product. An increase in the lapse rate increases the value of the enterprise and a decrease in lapse rate decreases value. The probability distribution of a lapse rate change from historical levels is assumed to be 25%/50%/25%, which give a standard deviation of $1074 per $1 million in force.

Another type of business risk that is modeled by the present method is the withdrawal rate for variable annuities. The withdrawal rate is assumed to be level over the term of the policy; that is, a withdrawal of the same amount each time funds are withdrawn. The terms of the particular insurance product determine the net present value, assuming the level withdrawal rate.

Still another type of business risk that is modeled in the present invention is the effect of the equity market on an enterprise's surplus capital including future profit of existing businesses when the enterprise offers variable annuities. The model looks at the “no withdrawal” and the “level withdrawal” scenarios for annuity assets, which are assumed to have a 25% and a 75% probability, respectively.

Some life insurance companies also offer investment type products, such as variable annuities. Insurance companies do not guarantee the returns of these products, the fund deposited with the insurance companies are kept in “separated accounts.” Insurance company's surplus capital is still affected by the return of these funds because the fee an insurance company can charge is directly related to the return and size of the funds. If the return on the separated accounts is less than expected, the amount of the funds will be lower than expected both from higher withdrawal and lower return.

In the foregoing, reference has been made to demographic segments. The risk exposure of life insurance products is based on the specific configuration of the existing policies by more than one dimension. For term life and life income annuities, the model configures them by age and contract maturity; for structured settlements, by payout pattern; for fixed annuities, by age and guarantee rate; and for variable annuities, by age of policy and guarantee rates. Similar breakdowns apply to other products. Demographic segmentation data can be supplied for the present model by the enterprise or from industry averages. Similarly, either the enterprise's lapse rate data or industry average data can be used.

Interest rate risk, which all types of insurance are exposed to, is determined by matching cash flow, as now described, and then analyzing future case flow as if it were a series of “zero coupon bonds.” The risk of each “zero coupon bond” is calculated and then the risk is reduced by the covariance benefits among all the zero coupon bonds. Modeling the impact of interest rates on life insurance products is more complicate because the interest rate changes not only change the discount rate of the future cash flows, but can also affect the behavior of the policyholders. For example, if interest rates increase, one would expect more fixed annuity policies will be surrendered because policyholders can earn more by withdrawing funds from fixed annuity accounts for investing in the bond market. However, the answer to the question of how sensitive is the withdrawal rate of policyholders to interest rate changes requires knowing who the policyholders are and how restrictive their contracts with the insurance companies are. In order to know how sensitive the values of some life insurance contracts to interest rates are, one has to model the behavior of the policyholders.

Life insurance and annuity products usually come with options for the customers to cancel the contract or to increase the size of the contract. For example, a customer can cancel his/her life insurance contract any time by not paying the insurance premium, or cancel his/her fixed annuity contract by withdrawing the fund deposited with the insurance companies. These options, that are unilaterally exercisable by an insured and that alter the normal course of the policy term, are thus similar to the options in residential mortgages that allow the pay off of the mortgage at a time chosen by the borrowers before maturity. The length of time until insurance contracts are cancelled greatly affects the profitability and value of those contracts. Insurance companies have to pay insurance agents commission to sell contracts. If insurance contracts are cancelled early, most likely the insurance companies will lose most of the commissions paid to acquire the contracts. Early cancellation adversely affects the companies' surplus capital. Therefore, the value of an insurance companies are very much dependent on the expected cancellation dates of their insurance contracts.

Customers of insurance may have the option to cancel a contract, but whether they will use this option is a function of many factors, including the cost of cancellation (i.e. surrender charge), the investment environment in the market, the competition from other insurance companies, the distribution channels of the contracts, social-economic characteristics of the customers and pure randomness. For example, if the policy was purchased through a career agent versus an independent agent, it may be more likely to be kept and not surrendered. If the interest rates increase, it is more likely for the customers to withdraw funds from the fixed annuity accounts. If the customers belong to a high-income group, they may be more sensitive to interest rate changes. In order to understand the volatility of the insurance contracts, one has to understand what drives the cancellation behavior and its magnitude.

The uncertainty in life insurance is analogous to that in residential mortgages. Mortgages are often paid off early or refinanced. There are many factors that can affect the refinancing behavior of mortgage customers, the factors include the nature of the mortgages, interest rates, the location of the properties, the social-economic and demographic characteristics of the customers. In order to value mortgage-based securities (MBS), one has to understand what motivates customers to refinance mortgages. Currently, others model mortgage refinancing behavior by applying sophisticated regression techniques on massive empirical data. The present model has adapted those modeling techniques to produce a similar technique in order to analyze cancellation behavior of life insurance customers.

We first collect data on individual insurance contracts for regression analysis. The dependent variable related to the cancellation behavior, which is the variable that we are modeling, is whether the insurance contract was cancelled that year. If the insurance contract is cancelled, the dependent variable is 1, otherwise, it is 0. The independent variables are all the possible factors that may motivate customers to cancel their insurance contracts, or discourage them from doing so. The first set of independent variables includes the nature of the insurance contract, whether it is a term life, whole life, variable annuity or fixed annuity, age, size, distribution channels and surrender charges of the contracts. The second set of independent variables includes the social-economic characteristics of the customers, including their income, wealth, age, and gender. The third set of independent variables includes the investment environment, such as interest rates, stock market returns, and alternative products from other insurance companies. The end result of this regression analysis is an equation that describes how the independent variables affect the likelihood of an insurance contract of being cancelled.

The regression results that describe the cancellation behaviors of insurance contract customers guide the present model to generate multiple cancellation scenarios. Each scenario of the multiple scenarios generated contains a possible future state of the world. Each future state contains information relating to the investment environment, such as interest rates, equity return, etc. The present model will feed the data on the investment environment into the regression equations as independent variables. The output is the probability that each insurance contract will be cancelled given other independent variables. Based on that probability, the present model then draws a random number to decide whether each insurance contract will be modeled as cancelled or not, and the surplus capital of the insurance companies will be determined accordingly.

We also use the concepts of “partial duration” and “partial convexity” to describe how sensitive are the values of insurance contracts to interest rate changes. ‘Partial duration’ is defined as the percentage change in asset value divided by the percentage change in interest rate. If the “partial duration” of an insurance contract is 2, and if the interest rate increases by one percentage point, the asset value increased by 2%. “Partial convexity” is defined as the percentage change in asset value divided by the product of the change in 2 interest rates. If the “partial convexity” of an insurance contract is 30, and the first interest rate increases by one percentage while the second interest rate decreases by 1%, then the asset value has increased by 30*1%*−1%=−0.3%. To calculate “partial duration”, we begin by changing one interest rate (e.g. 3 year rate) by a fixed amount. Then we calculate from the regression equations the cancellation probability. With the cancellation probability, we can calculate the expected cash flow from the insurance contracts and find the present value by discounting the future cash flows with appropriate rates. “Partial duration” is then the percentage change of asset divided by interest rate change.

To calculate “partial convexity”, we change two interest rates (e.g. 3 year rate and 5 year rate) by a fixed amount. Then we calculate from the regression equations the cancellation probability. With the cancellation probability, we calculate the expected cash flow from the insurance contracts and find the present value by discounting the future cash flows with appropriate rates. “Partial convexity” is then the percentage change of asset value divided by the product of the two interest rate changes. This process is performed on all type of insurance contracts so that it is much easier to understand their sensitivity to interest rate. This process has to be updated periodically in view of yield curves change. The behavioral regression model also needs to be updated periodically.

The present application models each asset and each type of liability. It then uses the scenarios it generates using quasi Monte Carlo techniques to calculate a surplus capital distribution one year forward for the enterprise. The value of each asset and each liability is calculated for each scenario and summed to build the distribution.

The report generated by the present model identifies the risk in uncertainty from each source of risk (credit, interest rate, etc.) and the risk including the benefits of the diversification of these various assets and liabilities. The net of the total risk from all five sources less the diversification benefit is the total risk of the enterprise, expressed in uncertainty. The report also calculates the number of dollars at risk of being lost with a 5% and a 1% probability, for example. In addition or alternatively, the report can contain the probability of losing certain percentages of surplus capital and of defaulting. Dividing the capital surplus by the risk, expressed in uncertainty, yields the enterprise risk model score, called the capital adequacy ratio, which can be compared to the scores for other enterprises to indicate the relative ranking of the risk of this particular enterprise.

Some enterprises are made of a number of divisions. The surplus capital distribution is produced in the aggregate and implicitly includes a diversification benefit. A well-diversified enterprise will have less risk associated with it than one that is focused on a single type of asset or a single type of liability (i.e., a single type of insurance policy).

An important feature of the present software application and model is the manner in which it allocates risk contribution and capital consumption among the divisions within an enterprise. Capital allocation is crucial for assessing financial performance of operating divisions. In theory, surplus capital is used to sustain shortfall in funds due to the uncertainty an enterprise will face. Therefore, a division that brings more risk to the enterprise has to be responsible for paying to “rent” of more surplus capital. Capital is therefore allocated based on risk contribution of each division.

An important feature of the present software model is the manner in which it allocates income. The operating divisions may not manage the assets of the enterprise; rather, those are left to a central investment division that has the mission of taking investment risks and earning investment yield spreads. The algorithm of the present model is based on the premise that income is only allocated to the divisions that took the risk associated with it. Therefore no investment risk should be assigned to the operating divisions when this is the case. Instead, a risk-free “synthetic asset” is created for each operating division mimic its liability cash outflow. As a result, operating divisions have only insurance risk and not also investment risk or interest rate risk, and only income from its operations is allocated back to the divisions, plus the interest income on the synthetic asset.

The operating divisions' risk contributions are based on their stand-alone risk less their allocated diversification benefits. After the individual divisions' risk contributions to the enterprise risk (including the diversification benefit) are known, the risk capital can be assigned to each division in proportion to its risk contribution (rather than in proportion to its stand-alone risk) and in the form of a liquid, risk-free investment. Implicitly the total diversification benefit of the enterprise is being allocated to each division based on the correlation structure among all the divisions in order to allocate capital. Each division's risk-adjusted-return-on-capital (RAROC) can then be determined by dividing the income allocated by capital allocated.

According to the present method, in order to calculate each division's risk contribution as adjusted for the diversification benefit, each division is arbitrarily divided into small “slices,” preferably 1000 slices. Then the enterprise is built up in many small steps. In each step, one slice of one division is added to the enterprise. Then the present software application calculates the enterprise risk. Then another slice of another division is added and the enterprise risk is calculated again. The difference between the two enterprise risks is said to be the risk contribution by one slice of the second division. Using this method, the risk contribution of each slice of each division is calculated. The sum of the risk contributions from each slice of each division can thus be added up to obtain the aggregate risk contribution of each division.

This approach to allocating capital is more accurate than allocation based on the size of the divisions' stand-alone risks, which tends to bias the results against those divisions that are less correlated with other divisions. It is also better than failing to allocate the diversification benefit at all, which also biases the results against the divisions that are less correlated. Furthermore, failing to allocate also underestimates the financial performance of all divisions because too much capital is assigned to all divisions. Risk contribution by division is driven by the marginal risk a segment adds to the enterprise risk. However, the size of marginal risk is dependent on the order the segments are added to the enterprise. Numerous iterations are required to calculate an “order-independent” risk contribution by segment—the number increases exponentially as the number of divisions increases. Unfortunately, the speed of the model is critical to the usefulness of the model.

The investment division pays the allocated risk capital to the operating divisions as if it were a return on the synthetic risk-free asset. The investment division's income is the yield spread between its own portfolio and the yield requirement of the synthetic investments that is paid to the operating divisions.

The present software application produces as output the total enterprise risk and the risk by categories (credit, equity, etc.). It reports the downside risks such as the probability of losing a certain percentage of capital, the probability of default, the expected policyholder deficit, and the expected loss in the event of default. When the enterprise has multiple divisions, the stand-alone risk of each division is reported along with its risk contribution, capital allocation and RAROC.

Downside risk can be defined arbitrarily as negative operating earnings, loss of 25% of capital, loss of 50% capital and a rating downgrade. The present model, in its preferred embodiment will estimate the probability of these events, and allow management to identify the causes of these risks so that they may be avoided or mitigated.

In addition to the afore-mentioned reported items, the present software application produces a “capital adequacy score” defined as the ratio of surplus to uncertainty of risk (both in the same units, i.e., dollars). The capital adequacy score determines, for an assumed normal distribution, a default threshold that, by its deviation from the mean of that distribution, indicates a maximum probability of default. The higher the capital adequacy score (that is, the higher the surplus capital and the lower the uncertainty.

The mathematical modeling of these assets and liabilities will now be described.

A. Quasi-Monte Carlo Method

There are several approaches to compute the distribution of a portfolio of asset in a VaR framework. Basically, it is either an analytic approach or a simulation approach. The analytic approach is the usual delta-gamma expansion; and the simulation approach is either historical simulation or Monte-Carlo simulation.

We will employ a full-valuation quasi-Monte Carlo method in calculating the distribution of the net worth of an insurance company in the present enterprise risk model. We chose the full-valuation Quasi-Monte Carlo method for the several important reasons. First, both credit risk and other market risks are integrated and calculated in the present model. As credit risk is highly non-local, the delta-gamma expansion is not appropriate. Second, a simple delta-gamma approximation is not a good approximation for log-normally distributed risk with moderate to high volatility. As the horizon of the present model is one year, volatility of both asset and insurance risk is not small. Volatility of some equity issues can be as high as 40%, making the usual delta-gamma approach invalid. Third, full-valuation simulation method is flexible enough to incorporate exotic derivative assets and exotic insurance risk, whereas the capability of the delta-gamma expansion is very limited in this area. Forth, the quasi-Monte Carlo method has a higher rate of convergence than the Monte Carlo method for problems with low effective dimension and most finance problems fall in this category.

Quasi-Monte Carlo (q-MC) methods are well suited for problems with low effective dimension. The effective dimension of a function is linked to its ANOVA decomposition. It is used to find a representation of a function ƒ with dimension t as a sum of orthogonal functions with lower or same dimensions. If most of the variance of the function can be explained by a sum of orthogonal functions with dimensions l≦s, then the effective dimension of function ƒ is s.

It is often the case in computational finance that the functions that are relevant have a low effective dimension in some sense. When this happens, even if the function is t-dimension with t large, a q-MC method based on a point set Pₙ that has good low-dimensional projections (i.e., such that the projection of Pₙ over the subspace of [0,1)^{t} with lower dimension is well distributed) can provide an accurate approximation. We denote the variables that associate with the low effective dimensions as important variables, i.e. variables that explain most of the variance of the function ƒ.

Identifying the important variables of the problem is the first step in the q-MC method. The natural solution to identifying the important variables in VaR framework is applying eigen-decomposition (principle of components) to a delta expansion. As mentioned above, delta expansion is not a very good approximation in calculating the distribution of the portfolio, but it is accurate enough for identifying the important variables.

Let us assume that the risk factors rᵢ follow the equations:
Δrᵢ=σᵢzᵢ,
where zᵢ are multi-normal distributed N(0, ρ) random variables. ρ is the correlation matrix of zᵢ. In delta expansion, a change in portfolio value ΔP is given by:

$$\begin{matrix}Δ P = {\sum }_{i} {\tilde{δ}}_{i} {z}_{i} \\ and \\ {\tilde{δ}}_{i} = \frac{\partial P}{\partial {r}_{i}} {σ}_{i} .\end{matrix}$$

Applying eigen-decomposition (see next section) to zᵢ,

$${z}_{i} = {\sum }_{l} {A}_{il} {x}_{l} \qquad {x}_{l} ∼ N ( 0 , I )$$

and
A=UΩ.
Here U is a matrix of column eigenvectors of ρ and Ω is a diagonal matrix with the diagonal elements being the square roots of eigenvalues of ρ. Therefore ΔP can be rewritten as

$$\begin{matrix}Δ P = {\sum }_{i} {\sum }_{i} {\tilde{δ}}_{i} {A}_{il} {x}_{l} \\ = {\sum }_{l} ( {\sum }_{i} {\tilde{δ}}_{i} {A}_{il} ) {x}_{l} \\ = {\sum }_{l} {B}_{l} {x}_{l} \\ where \\ {B}_{l} = {\sum }_{i} {\tilde{δ}}_{i} {A}_{il} .\end{matrix}$$

The variance of ΔP is

$$\begin{matrix}Var ( Δ P ) = {\sum }_{l} {\sum }_{j} {B}_{l} {B}_{j} Cov ( {x}_{l} , {x}_{j} ) \\ = {\sum }_{l} {B}_{l}^{2} .\end{matrix}$$

This equation indicates that the contribution of xₗ to the variance of ΔP is Bₗ². This interpretation points to the following procedure of ordering xₗ according to its importance:

The eigen-decomposition of zᵢ is obtained and then the matrix A is calculated. Then we calculate:

$${B}_{l} = {\sum }_{i} {\tilde{δ}}_{i} {A}_{il} .$$

Bₗ is ordered so that B₁≧B₂≧B₃≧ . . . ≧Bₜ. The matrix A is rearranged accordingly. As A=UΩ, the diagonal element in Ω and column eigenvectors in U according to the order in B₁≧B₂≧B₃≧ . . . ≧Bₜ are re-ordered. Denote the rearranged matrix A as A′.

Generate uniform Quasi-Random number point sets

$${P}_{n} = \{ \begin{matrix}( {u}_{0}^{i} , {u}_{1}^{i} , {u}_{2}^{i} , … , {u}_{t - 1}^{i} ) , \\ i ∈ \{ 1 , 2 , 3 , … , n \}\end{matrix} \} ,$$

which have good low-dimensional projections. Here
(u₀ⁱ, u₁ⁱ, u₂ⁱ, . . . , uₜ₋₁ⁱ)ε[0,1)′.

The model transforms (u₀ⁱ, u₁ⁱ, u₂ⁱ, . . . , uₜ₋₁ⁱ) into (x₀ⁱ, x₁ⁱ, x₂ⁱ, . . . , xₜ₋₁ⁱ)˜N(0,I) by the inverse cumulative normal function.

Then we obtain z˜N(0, ρ) by the equation z=A′x and the change in risk factors Δrᵢ by Δrᵢ=σᵢzᵢ.

We next implement the uniform quasi-random number generator based on lattice rules. Korobov rules are a special case of lattice rules that are easy to implement. The point set Pₙ, for a given sample size n, is equal to the set of all vectors of t (t is the dimension of the space) successive output values produced by the linear congruential generator (LCG) defined by the recurrence
yⱼ=(ayⱼ₋₁) mod n, j=1, 2, . . . t−1
uⱼ=yⱼ/n.
where the initial point y₀ε{0, 1, . . . n−1}. The quasi-random number set is
Pₙ={(u₀, u₁, . . . , uₜ₋₁)∀y₀}.

The following table gives the best multipliers a corresponding to certain sample size n, in terms of the criteria that some of the low-dimensional projections be well distributed.

| n | a |
|---|---|
| 8191 | 5130 |
| 16381 | 4026 |
| 32749 | 14251 |

B. Eigen-Decomposition and Singular Value Decomposition

If a set of random variables X˜N(μ, Σ) and another set of random variables Y are related by the equation Y=AX+b, where A is a matrix and b is a vector, then Y˜N(Aμ+b,AΣA^{T}). A^{T} is the transpose of A. In particular, if X˜N(0,I) and Y=AX, then Y˜N(0,AA^{T}).

For a given covariance matrix Σ², we always want to find the decomposition of Σ², i.e. a matrix A such that if Y˜N(0, Σ²) and X˜N(0, I), then Y=AX. From the above observation, we can identify Σ²=AA^{T}. As A is not unique, there are several ways of finding the matrix.

We know that Σ² is the covariance-variance matrix. It is semi-positive definite. Let us assume that Σ² is a N by N matrix, then A is also N by N. First, let us apply singular decomposition on A, i.e. there exists N by N matrix U, Ω and V such that
A=UΩV^{T}
where Ω is a diagonal matrix. U and V are orthonormal:
U^{T}U=UU^{T=I, V}^{T}V=VV^{T}=I.
Therefore,
AA^{T}=(UΩV^{T})(VΩ^{T}U^{T})
and
=UΩΩ^{T}U^{T}
so that A can be decomposed as A=UΩ. By the fact that Σ²=A^{T}A and the eigen-decomposition of Σ²=EΛE^{T} where E is the matrix of column eigenvector of Σ², we can identify U with E and Ω² with Λ because of the following equations:
EΛE^{T}=Σ²=AA^{T}=UΩΩ^{T}U^{T}=UΩ²U^{T}.

Therefore, one of the decomposition of A is
A=UΩ
where U is the matrix of column eigenvectors of Σ² and Ω is the diagonal matrix with the diagonal elements the square root of eigenvalues of Σ². With this decomposition,
Y=UΩX where X˜N(0,I) and Y˜N(0,Σ²).
C. Stocks and Factor Loading

In the case of factor loading, we assume that for any obligor v, the standardized log return of the firm's value, rₙ^{v} is the weighted average of two standardized returns, namely, the industry return, rₙ^{I} and the firm-specific return, ε:
rₙ^{v}=w_{I}rₙ^{I}+\sqrt{1−w_{I}²}ε.

The practical interpretation of the above equation is that the firm's return can be sufficiently explained by the index return of the industry classification to which the firm belongs, with a residual part that can be explained solely by information unique and specific to the firm. The industry-specific return in the above equation can be generalized to multi-industry returns. In that case, rₙ^{I} will be expressed as a weighted sum of standardized returns on the industry returns.

Firm-specific risk can generally be considered to be a function of company asset size. Larger companies tend to have smaller firm-specific risk while smaller companies, on the other hand, tend to have larger firm-specific risk. According JP Morgan's CreditManager, the firm-specific risk follows the logistic curve:

$$firmSpecificRisk = \frac{1}{2 ( 1 + {Assets}^{0.4884} \times {ⅇ}^{- 12.4739} )} ,$$

where Assets=total assets in US dollars. For asset size of $1 billion, firm-specific risk is 0.46, implying w_{I}=0.54. For asset size of $100 billion, w_{I}=0.75.

From the asset size of the firm, we can compute the firm-specific risk by JP Morgan's logistic equation and hence determine the weight w_{I}. If the firm belongs to one industry group, a standardized return of the firm is specified. However, as we mentioned above, a firm's return movement may be explained by more than one industry index. In that case, we need to decompose rₙ^{I} in terms of standardized industry returns.

Assume that the participation of firm v in industry i is βᵢ, i=1, 2, . . . , n, with

$${\sum }_{i}^{n} {β}_{i} = 1.$$

Define firm's weighted industry index:

$${r}^{I} = {\sum }_{i}^{n} {β}_{i} {r}^{i} ,$$

where rⁱ is the total return (not standardized) of industry index. Suppose that the returns on the industry indices have volatilities given by σᵢ and correlation given by ρᵢⱼ, then the volatility of the firm's weighted industry index r^{I} is:

$$\begin{matrix}{σ}_{I}^{2} = {\sum }_{ij} {β}_{i} {β}_{j} {ρ}_{ij} {σ}_{i} {σ}_{j} , \\ {r}_{n}^{I} = \frac{{r}^{I}}{{σ}_{I}} = {\sum }_{i}^{n} \frac{{β}_{i}}{{σ}_{I}} {r}^{i} = {\sum }_{i}^{n} ( \frac{{β}_{i}}{{σ}_{I}} {σ}_{i} ) {r}_{n}^{i} \\ Hence , \\ {r}_{n}^{I} = {\sum }_{i}^{n} {α}_{i} {r}_{n}^{i} with {α}_{i} = \frac{{β}_{i}}{{σ}_{I}} {σ}_{i} ,\end{matrix}$$

And a firm's standardized return can be expressed as

$${r}_{n}^{v} = {w}_{I} [ {\sum }_{i} {α}_{i} {r}_{n}^{i} ] + \sqrt{1 - {w}_{I}^{2}} ɛ .$$

The above discussion makes the assumption that standardized equity return of the firm is a good proxy for standardized return on firm's value. Hence, denote standardized equity return of the firm as rₙ^{e},
rₙ^{v}≈rₙ^{e},
and if one knows the volatility of equity return (σₑ), we can model equity return of the firm as

$$\begin{matrix}{r}^{e} = {σ}_{e} \cdot {r}_{n}^{e} \\ \approx {σ}_{e} \cdot {r}_{n}^{v} \\ = {σ}_{e} \cdot ( {w}_{I} [ {\sum }_{i} {α}_{i} {r}_{n}^{i} ] + \sqrt{1 - {w}_{I}^{2}} ɛ ) \\ = {w}_{I} [ {\sum }_{i} \frac{{σ}_{e}}{{σ}_{I}} {β}_{i} {r}^{i} ] + {σ}_{e} \cdot \sqrt{1 - {w}_{I}^{2}} ɛ .\end{matrix}$$

If there is no information on the volatility of equity return, we may make the assumption that σₑ=σ_{I}, as given in the above equation. Then,

$${r}^{e} = {w}_{I} [ {\sum }_{i} {β}_{i} {r}^{i} ] + {σ}_{I} \cdot \sqrt{1 - {w}_{I}^{2}} ɛ .$$

The general form of equity return is

$$\begin{matrix}{r}^{e} = {w}_{I} [ {\sum }_{i} {γ}_{i} {r}^{i} ] + σ \cdot \sqrt{1 - {w}_{I}^{2}} ɛ \\ with \\ \begin{matrix}\{ \begin{matrix}{γ}_{i} = {β}_{i} \\ σ = {σ}_{I}\end{matrix} & & & or & & & \{ \begin{matrix}{γ}_{i} = \frac{{σ}_{e}}{{σ}_{I}} {β}_{i} \\ σ = {σ}_{e}\end{matrix} .\end{matrix}\end{matrix}$$

The price of the single equity is

$${P}_{t + h} = {P}_{t} \cdot exp ( {r}^{e} ) = {P}_{t} \cdot exp ( {w}_{I} [ {\sum }_{i} {γ}_{i} {r}^{i} ] + σ \cdot \sqrt{1 - {w}_{I}^{2}} ɛ )$$

which is log-normally distributed. The mean of the stock price conditional on rⁱ, i.e., rⁱ being known, is

$$\begin{matrix}mean ( {P}_{t + h} \vert {r}^{i} ) = {E}_{{r}^{i}} [ {P}_{t + h} ] \\ = {P}_{t} \cdot exp ( {w}_{I} [ {\sum }_{i} {γ}_{i} {r}^{i} ] ) \cdot {E}_{{r}^{i}} [ exp ( σ \cdot \sqrt{1 - {w}_{I}^{2}} ɛ ) ] \\ = {P}_{t} \cdot exp ( {w}_{I} [ {\sum }_{i} {γ}_{i} {r}^{i} ] + \frac{1}{2} ( 1 - {w}_{I}^{2} ) {σ}^{2} ) .\end{matrix}$$

The conditional variance is

$$\begin{matrix}Var ( {P}_{t + h} \vert {r}^{i} ) = {E}_{{r}^{i}} [ {P}_{t + h}^{2} ] - {( {E}_{{r}^{i}} [ {P}_{t + h} ] )}^{2} \\ = {P}_{t}^{2} \cdot exp ( 2 {w}_{I} [ {\sum }_{i} {γ}_{i} {r}^{i} ] + ( 1 - {w}_{I}^{2} ) {σ}^{2} ) \cdot [ exp ( ( 1 - {w}_{I}^{2} ) \cdot {σ}^{2} ) - 1 ] .\end{matrix}$$

For a portfolio of stocks, the conditional mean and conditional variance are just the sum of individual means and variances. Noticing that firm specific risks are independent with each other can easily prove that Cov(P₊ₕⁱ,Pₜ₊ₕ^{k}|rⁱ)=0 and the mentioned results follow.

D. Bonds

There are several ways to classify a bond:
(i) Risk Free bond and Risky (Default risk) bond,
(ii) Domestic bond and International bond, and
(iii) Sovereign (Government) bond, Municipal bond and Corporate bond.

All sovereign (government) bonds issued in domestic currencies have no default risk; i.e., they are “risk-free bonds.” Countries can meet their debt payment obligations in their own currencies, on which their central bank has a monopoly. Domestic sovereign bonds prices determine the domestic risk-free yield curves. In other words, a domestic sovereign bond should be discounted using domestic risk-free yield curve.

Industrialized countries usually issue sovereign bonds in their own currencies. In rare cases, they issue bonds in foreign currency, which we may still assume is default free, but the bonds should be discounted with the foreign risk-free yield curve.

All bonds other than risk free bond are risky bonds. These include
(i) sovereign bonds of developing countries, in foreign currency (usually in US dollars, Yen, etc . . . ); and
(ii) municipal bonds and corporate bonds, in both domestic and foreign currencies.

In order to value a risky bond, more variables (as compared to risk-free bonds) need to be specified: namely, credit spread as a function of maturity, rating and country. In addition, for corporate bonds calculated in reference to issuer's domestic yield curve, and for sovereign bonds of developing countries issued in foreign currency and calculated in reference to risk-free yield curve of foreign currency, the recovery rate in default needs to be specified.

Discount factors of a risky bond are determined by the sum of
(i) risk-free yield curve corresponding to the bond's denominated currency, and
(ii) the credit spread (the credit spread of municipal bond is assumed to be the same as that of corporate bonds).

Data showing the recovery-rate-in-default may not exist for some countries, especially for developing countries. The present method uses the following numbers as default value:
(i) recovery rate of corporate bonds in developing countries usually is very low (assume 10% with standard deviation 10%);
(ii) recovery rate of corporate bonds in developed countries is assumed to be similar to that of US corporate bonds (use the US corporate bond recovery rates as proxy);
(iii) recovery rate of sovereign bond is assumed to be 60% with standard deviation of 30% because there is always restructuring after default and help from International Monetary Fund, world bank and developed countries;
(iv) recovery rate of municipal bonds in developing countries should be better than that for corporate bonds (assume it is 30% with a standard deviation of 20%); and
(v) recovery rate of municipal bonds in developed countries is assumed to be equivalent to a senior secured corporate bond.

For the factor loading for risky sovereign bond and municipal bond, the country index is used. w_{I} for risky sovereign bonds and municipal bonds in the equation rₙ^{v}=w_{I}rₙ^{l}+\sqrt{1−w_{I}²}ε are assumed to be 0.8 and 0.6, respectively.

E. Cash Flow Mapping and Risk Free Bonds

In the present enterprise risk model, the horizon is one year, which is quite long. The usual VaR methodology does not apply and “long run” methodology should be used. We are interested in the volatility of the present value of future cash flow one year from now. Therefore, we need to construct a forward rate from the current yield curve and use the forward rate for discounting.

Assume we have the yield curve rₜ. Note that we only observe rᵢ at a reduced set of maturities tᵢ for i=1, 2 . . . n. Forward rate ƒₜ_{ᵢ} at time horizon h, assuming annual compounding, is:
(1+rₕ)^{h}(1+ƒₜ_{ᵢ})^{t}^{ᵢ}^{-h}=(1+rₜ^{ᵢ})^{t}^{ᵢ}

$${f}_{{t}_{i}} = {[ \frac{{( 1 + {r}_{{t}_{i}} )}^{{t}_{i}}}{{( 1 + {r}_{h} )}^{h}} ]}^{\frac{1}{( {t}_{i} - h )}} - 1.$$

For continuous compounding: e^{r}^{ₕ}^{h}e^{ƒ}, (i-h)=erjll

$${f}_{{t}_{i}} = \frac{{r}_{{t}_{i}} {t}_{i} - {r}_{h} h}{{t}_{i} - h} .$$

So that given any cash flow Cₜ_{ᵢ}, the present value of Cₜ_{ᵢ} at time horizon h is:
PVₕ(Cₜ_{ᵢ})=Cₜ_{ᵢ}/(1+ƒₜ_{ᵢ})ⁱ^{ᵢ}^{-h} (annual compounding)
and
PVₕ(Cₜ_{ᵢ})=Cₜ_{ᵢ}e^{-ƒ}₋ₕ₎ (continuous compounding).
In the present enterprise risk model, each US denominated cash flow is mapped to one or more of the vertices shown below.
<=1 yr 2 yrs 3 yrs 4 yrs 5 yrs 7 yrs 9 yrs 10 yrs 15 yrs 20 yrs 30 yrs >30 yrs

Below we illustrate how to map a cash flow Cₜ with t ε(t_{L},t_{R}) to the left and right vertices t_{L},t_{R}. Define:
α=(t_{R}−t)/(t_{R}−t_{L}).

Assume continuous compounding
hrₕ+ƒ_{R}(t_{R}−h)=r_{R}tᵣ
hrₕ+ƒ_{L}(t_{R}−h)=r_{L}t_{L}.

In RiskMetrics “Improved Cashflow Map”, the “flat forwards” assumption is made to arrive at the following interpolation:

$${r}_{t} = \frac{{t}_{L}}{t} α {r}_{L} + \frac{{t}_{R}}{t} ( 1 - α ) {r}_{R} .$$

Substituting it into the forward rate equation:
ƒₜ=(rₜt−hrₕ)/(t−h),
one gets
ƒₜ=α[(t_{L}−h)/(t−h)]ƒ_{L}+(1−α)[(t_{R}−h)/(t−h)]ƒ_{R}.

Following the argument of the “Improved Cashflow Map” and denoting Pₜ=e^{-(t-h)ƒ}^{ₜ} as the price of a zero coupon bond maturing at time t evaluated at time horizon h, one can arrive at Rₜ=αR_{L}+(1−α)R_{R} where Rₜ is the log return of the zero coupon bond. Assuming Rₜ is small:

$$\begin{matrix}{\hat{P}}_{t} = {P}_{t} ( 1 + {R}_{t} ) \\ = {P}_{t} ( 1 + α {R}_{C} + ( 1 - α ) {R}_{R} ) \\ = {P}_{t} [ α ( {\hat{P}}_{L} / {P}_{L} ) + ( 1 - α ) ( {\hat{P}}_{R} / {P}_{R} ) ] .\end{matrix}$$

From the above equation, it is clear that a cash flow of Pₜ dollars invested in a zero coupon bond maturing at time t can be replicated by a portfolio consisting of αPₜ dollars invested in a bond maturing equal to the left vertex, and (1−α)Pₜ dollars invested in a bond with maturity equal to the right vertex.

If cash flow Cₜ happens to be right on one of the vertices, the cash flow can be discounted with the equation:
PVₕ(Cₜ)=Cₜe^{-ƒ}^{ₜ}^{(t-h)}

Allocate PVₕ(Cₜ) to the corresponding vertex. If cash flow Cₜ falls between two vertices, i.e. tε(t_{L},t_{R}), discount the cash flow with the same equation PVₕ(Cₜ)=Cₜe^{-ƒ}^{ₜ}^{(t-h)} but with forward rate
ƒₜ=α[(t_{L}−h)/(t−h)]ƒ_{L}+(1−α)[(t_{R}−h)/(t−h)]ƒ_{R}.
Allocate α·PVₕ(Cₜ) to the left vertex and (1−α)·PVₕ(Cₜ) to the right vertex.

We assume that the log return on the market value of a risk-free zero coupon bond follows a conditional normal distribution (using the same assumptions as used by RiskMetrics). Therefore, for any risk-free zero coupon bond with maturity t that coincides with any one of the vertices, the market value distribution at time horizon h is given by the following equation:
MVₕ(Fₜ)=PVₕ(Fₜ)e^{R}^{ₜ}
where Rₜ is the log return, a random variable, and Fₜ is the face value of the risk-free zero coupon bond.

If the maturity of the risk-free zero coupon bond falls between two vertices, we first map the face value of the risk-free zero coupon bond into the corresponding vertices, and the market value distribution can then be evaluated accordingly:
MVₕ(Fₜ)=α·PVₕ(Fₜ)e^{R, +(l-a) PV,,(F,)eRI}
wherein Rₜ_{_{L}} and Rₜ_{_{R}} are the log returns of risk-free zero coupon bonds of left and right vertices.

As any risk-free bond can be decomposed into cash flows, the market value distribution of a portfolio of risk-free coupon bonds can be evaluated by the following procedure:

Decompose a coupon bond j in the bond portfolio into corresponding cash flows Cₜ^{j}. Map the cash flows Cₜ^{j} to the individual vertices, denoted as Vₜ_{ᵢ}^{j}. We next repeat the above steps for every bond in the portfolio and sum up Vₜ_{ᵢ}^{j}.

The market value of the portfolio is

$${MV}_{h} = {\sum }_{{t}_{i} ∈ vertices}^{} ( {\sum }_{j}^{} {V}_{{t}_{i}}^{j} ) {ⅇ}^{{R}_{{1}_{i}}}$$

where Rₜ_{ᵢ} is the log return of a zero coupon bond with maturity tᵢ. In the simulation, Rₜ_{ᵢ} will be applies to the above formula in order to evaluate the distribution of the market value of a bond or a portfolio of bonds.

For cash flow that is within the time horizon, we take the conservative approach and assume that the cash flow earns no interest and so the present value at the horizon is just the sum of the cash flows. The assumption that the cash flow earns no interest leads to the conclusion that this cash flow has no interest rate risk.

For cash flow that is in the last vertex, i.e., >30 yrs vertex in US currency, we will assume that it has the same forward rate as the second to last vertex and use it to calculate the present value of the cash flow and group it under second to last vertex.

F. Risky Bonds

The market value of a risky bond Vₕ at horizon h can be written as:

$${V}_{h} = {\sum }_{s = 1}^{m} [ θ ( {r}_{u}^{v} - {z}^{s + 1} ) - θ ( {r}_{n}^{v} - {z}^{s} ) ] {B}_{s}$$

where

θ is the step function:

$$θ ( x ) = \{ \begin{matrix}0 & x < 0 \\ 1 & x \geq 1\end{matrix} ,$$

and s denotes the possible rating states. s=1, . . . m, with s=1 corresponding to the highest rating, s=m corresponding to default. z^{s} is the rating thresholds and rₙ^{v} is the standardized log return of the firm's value. The enterprise will be in a “non-default” rating states if z^{s+1}≦rₙ^{v}<z^{s} and will be in a “default” rating state if rₙ^{v}<z^{m}. We also set z¹=∞ and z^{m+1}=−∞.

Bₛ is the value of the risky bond if the firm is in rating states at the horizon h. Bₛ is a function of forward risk free rate curve and forward credit spread rate curve. In general, for s≠m,

$${B}_{s} = {\sum }_{j}^{} B ( {t}_{j} ) {ⅇ}^{- ( {t}_{j} - h ) {Δ}_{s} ( {t}_{j} )} ,$$

where Δₛ(tⱼ)=forward credit spread with maturity at tⱼ and rating s and B(tⱼ) is value of the corresponding risk-free zero coupon bond with maturity tⱼ, evaluated at horizon h.

For s=m, i.e., in default state
Bₘ=F·RFV

F=Face value of the bond

RFV=recovery rate of face value, a random variable, with mean \overline{RFV} and standard deviation σ_{RFV}, which depends on the seniority of the debt.

z^{s} can be calculated from the information provided by transition matrix and the initial rating of the bond. Assume that we know the transition probability P^{s},s=1, . . . m, then

$${z}^{s} = {Φ}^{- 1} [ {\sum }_{l = s}^{m} {P}^{l} ] \qquad s - 2 , … m ,$$

wherein Φ is the cumulative distribution function (CDF) for the standard normal distribution.

We assume that the standardized return of the firm's value can be expressed by
rₙ^{v}=wₑrₙ^{e}+\sqrt{1−wₑ²}ε

where rₙ^{e} is the standardized return on the corresponding equity market index of the industry to what the firm belongs. The firm structure may be an aggregate of several industry groups. In that case, weights are assigned according to the firm's participation in the industries and rₙ^{e} is the weighted sum of the returns on the indices. We assume that rₙ^{e}, ε are independent, normally distributed random variables with mean “0” and variance “1.”

If we fix rₙ^{e} (in simulation, all risk factors will be generated according to the variance-covariance structure of risk factors, equity indices being some of them), the condition that rₙ^{v} is less than a threshold z^{s} becomes

$$ɛ < \frac{{z}^{s} - {w}_{e} {r}_{n}^{e}}{\sqrt{1 - {w}_{e}^{2}}} .$$

The conditional default probability then becomes:

$${P}^{m} ( {r}_{n}^{e} ) = Φ [ \frac{{z}^{m} - {w}_{e} {r}_{n}^{e}}{\sqrt{1 - {w}_{e}^{2}}} ]$$

and the transition probabilities are:

$${P}^{s} ( {r}_{n}^{e} ) = Φ [ \frac{{z}^{s} - {w}_{e} {r}_{n}^{e}}{\sqrt{1 - {w}_{e}^{2}}} ] - Φ [ \frac{{z}^{s + 1} - {w}_{e} {r}_{n}^{e}}{\sqrt{1 - {w}_{e}^{2}}} ] \qquad s = 1 , … m - 1.$$

The conditional mean of the market value of the risky bond is (r in the argument of conditional mean represents risk factors other than rₙ^{e}),

$$\begin{matrix}m ( {r}_{n}^{e} , r ) = {E}_{r} [ {P}_{h} ] \\ = {\sum }_{s = 1}^{m} {E}_{r} \{ \vert θ ( {r}_{n}^{v} - {z}^{s + 1} ) - ( θ ( {r}_{n}^{v} - {z}^{s} ) ] {B}_{s} \} \\ = {\sum }_{s = 1}^{m} {E}_{r} [ θ ( {r}_{n}^{v} - {z}^{s + 1} ) - θ ( {r}_{n}^{v} - {z}^{s} ) ] {E}_{r} [ {B}_{s} ] \\ = {\sum }_{s = 1}^{m} {P}^{s} ( {r}_{n}^{e} ) {E}_{r} [ {B}_{s} ] ,\end{matrix}$$

wherein Eᵣ is the expected value over firm specific risk and recovery rate risk conditioned on all other risk factors (interest rate, equity, FX . . . ) being fixed. We also assume that firm specific risk and recovery rate risk are independent.

Hence

$${E}_{r} [ {B}_{s} ] = \{ \begin{matrix}{B}_{s} ( r ) & s \neq m \\ F \cdot \overline{RFV} & s = m\end{matrix} .$$

The conditional variance of the market value of the risky bond is

$$\begin{matrix}{σ}^{2} ( {r}_{n}^{e} , r ) = {E}_{r} ⌊ {( {P}_{h} - m )}^{2} ⌋ \\ = {E}_{r} ( {P}_{h}^{2} ) - {m}^{2} \\ = {E}_{r} [ {\sum }_{s = 1}^{m} {\sum }_{ℓ = 1}^{m} [ θ ( {r}_{n}^{e} - {z}^{s + 1} ) - θ ( {r}_{n}^{e} - {z}^{s} ) ] \\ [ θ ( {r}_{n}^{e} - {z}^{ℓ + 1} ) - θ ( {r}_{n}^{e} - {z}^{ℓ} ) ] {B}_{s} {B}_{ℓ} ] - {m}^{2} \\ = {\sum }_{s = 1}^{m} {E}_{r} [ θ ( {r}_{n}^{e} - {z}^{s + 1} ) - θ ( {r}_{n}^{e} - {z}^{s} ) ] {E}_{r} [ {B}_{s}^{2} ] - {m}^{2}\end{matrix}$$

where the identity

$${E}_{r} \{ ⌊ θ ( {r}_{n}^{e} - {z}^{s + 1} ) - θ ( {r}_{n}^{e} - {z}^{s} ) ⌋ ⌊ θ ( {r}_{n}^{e} - {z}^{ℓ + 1} ) - θ ( {r}_{n}^{e} - {z}^{ℓ} ) ⌋ \} = {δ}_{s , ℓ} {E}_{r} [ θ ( {r}_{n}^{e} - {z}^{s + 1} ) - θ ( {r}_{n}^{e} - {z}^{s} ) ] = {δ}_{s , ℓ} {P}^{s} ( {r}_{n}^{e} )$$

has been used. Therefore the conditional variance becomes

$$\begin{matrix}{σ}^{2} ( {r}_{n}^{e} , r ) = {\sum }_{s = 1}^{m} {P}^{s} ( {r}_{n}^{e} ) {E}_{r} ( {B}_{s}^{2} ) - {m}^{2} \\ = {\sum }_{s = 1}^{m} {P}^{s} ( {r}_{n}^{e} ) [ {E}_{r} ( {B}_{s}^{2} ) - {m}^{2} ] \\ {E}_{r} ( {B}_{s}^{2} ) = \{ \begin{matrix}{B}_{s}^{2} & s \neq m \\ {F}^{2} ( {σ}_{RFV}^{2} + {\overline{RFV}}^{2} ) & s = m\end{matrix} .\end{matrix}$$

Assume we have N risky bonds and market value of bond i at horizon h is Vₕⁱ.

$$\begin{matrix}{V}_{h} = {\sum }_{i = 1}^{N} {\sum }_{s = 1}^{m} [ {h}_{s}^{i} {B}_{s}^{i} ] = {\sum }_{i = 1}^{N} {V}_{h}^{i} . \\ Here \\ \begin{matrix}{B}_{s}^{i} = {\sum }_{j} {B}^{i} ( {t}_{j} ) {ⅇ}^{- ( {t}_{j}^{i} - h ) {Δ}_{s}^{i} ( {t}_{j}^{i} )} & & & s \neq m\end{matrix} \\ \begin{matrix}{B}_{m}^{i} = {F}^{i} {RFV}_{i} & & & s = m\end{matrix} \\ {h}_{s}^{i} = θ ( {r}_{i}^{v} - {z}_{i}^{s + 1} ) - θ ( {r}_{i}^{v} - {z}_{i}^{s} ) \\ \begin{matrix}{z}_{i}^{s} = {Φ}^{- 1} [ {\sum }_{ℓ = s}^{m} {P}_{i}^{ℓ} ] & & & s = 2 , … m\end{matrix} \\ {r}_{i}^{v} = {w}_{i} {r}_{i}^{e} + \sqrt{1 - {w}_{i}^{2}} {ɛ}_{i} . \\ {P}_{i}^{ℓ} = the transition probability of firm i \\ from initial rating to rating ℓ .\end{matrix}$$

Both rᵢ^{v} and rᵢ^{e} are standardized return of the firm's value and standardized weighted sum of returns on the industry indices corresponding to the industries to which the firm belongs. wᵢ is the set of weightings that depend on the asset size of the firm. εᵢ is independent, normally distributed random variables, with mean zero and variance one.

Individual conditional mean

$$\begin{matrix}{m}_{i} ( {r}_{i}^{e} , r ) = {\sum }_{s = 1}^{m} {P}_{i}^{s} ( {r}_{i}^{e} ) {E}_{r} [ {B}_{s}^{i} ] \\ {E}_{r} ⌊ {B}_{s}^{i} ⌋ = \{ \begin{matrix}{B}_{s}^{i} ( r ) & s \neq m \\ {B}_{s}^{i} ( v ) \cdot {\overline{RFV}}_{i} & s = m\end{matrix} .\end{matrix}$$

Portfolio conditional mean is given by

$$m ( r ) = {\sum }_{i}^{N} {m}_{i} ( {r}_{i}^{e} , r ) .$$

Individual conditional variance is

$$\begin{matrix}{σ}_{i}^{2} ( {r}_{i}^{e} , r ) = {\sum }_{s = 1}^{m} {P}_{i}^{s} ( {r}_{i}^{e} ) [ {E}_{r} ( {( {B}_{s}^{i} )}^{2} ) - {m}_{i}^{2} ] \\ {E}_{r} ⌊ {( {B}_{s}^{i} )}^{2} ⌋ = \{ \begin{matrix}{{B}_{s}^{i} ( r )}^{2} & s \neq m \\ {( {F}^{i} )}^{2} [ {σ}_{{RFV}_{i}}^{2} + {\overline{RFV}}_{i}^{2} ] & s = m\end{matrix} .\end{matrix}$$

Portfolio conditional variance in terms of individual conditional variance is

$${σ}^{2} ( r ) = {\sum }_{i = 1}^{N} {σ}_{i}^{2} ( {r}_{i}^{e} , r ) .$$

Once r is fixed, only εᵢ and RFVᵢ are random. Vₕⁱ is a function of εᵢ and RFVᵢ only. But εᵢ, RFVᵢ are independent of each other. Hence cov(εᵢ,εⱼ)=0 for i≠j, cov(RFVᵢ,RFVⱼ)=0 for i≠j, cov(εᵢ,RFVⱼ)=0 for all i and j. Therefore,

$$Var ( {V}_{h} ) = {\sum }_{i} Var ( {V}_{h}^{i} ) .$$

Because εᵢ are independent variables, we can apply Central Limit Theorem if the number of bonds in the portfolio is large enough, say, more than 30 bonds. In that case, we can assume that, for a given realization of the market factors, the portfolio distribution of the risky bond is conditionally normal, with mean m(r) and variance σ²(r).
Vₕ|ᵣ˜N(m(r),σ²(r)).

In simulation, the market value distribution of a portfolio of risky coupon bonds can be evaluated by the following procedure: First, we decompose a risky coupon bond i in the risky bond portfolio into corresponding cash flows Cₜⁱ. Then map the cash flows Cₜⁱ to the individual vertices, denoted as Bⁱ(tⱼ), as defined in risk-free bond cash flow mapping. It is the same cash flow map as that in risk-free bond.

For each vertex, we calculate
Bⁱ(tⱼ)e^{-(t}^{ⱼ}^{-h)Δ}^{ₛ}^{(t}_{ᵢ}⁾ for s=1 . . . m−1,
\overline{B}ₘⁱ=Fⁱ·\overline{RFV}ᵢ and

$${( {F}^{i} )}^{2} ⌊ {σ}_{{RFV}_{i}}^{2} + {\overline{RFV}}_{i}^{2} ⌋ .$$

We next calculate the rating thresholds

$${z}_{i}^{s} = {Φ}^{- 1} [ {\sum }_{ℓ = s}^{m} {P}_{i}^{ℓ} ] .$$

The above steps are repeated for every bond in the portfolio.

To simulate the possible scenarios, we generate risk factors: Rₜ_{ⱼ}, the log return of a zero coupon bond with maturity tⱼ and R^{e}, the log return of industry indices, and other risk factors. Then for every bond i in the portfolio, we calculate rᵢ^{e}, the standardized weighted sum of returns on the industry indices of firm i. We calculate
Bₛⁱ(r)=Bⁱ(tⱼ)e⁻(t^{_{i−h)Δ}}^{ₛ}^{(t}^{ⱼ}⁾e^{Rj}
for s=1, . . . m−1.
The conditional transition probability is calculated from
Pᵢ^{s}(rᵢ^{e}) for s=1, . . . m.
We then calculate mᵢ(rᵢ^{e},r) and σᵢ²(rᵢ^{e},r). The above steps are repeated for every bond i in the portfolio and sum up total conditional mean and conditional variance of the portfolio:

$$m ( r ) = {\sum }_{i}^{N} {m}_{i} ( {r}_{i}^{e} , r ) and {σ}^{2} ( r ) = {\sum }_{i = 1}^{N} {σ}_{i}^{2} ( {r}_{i}^{e} , r ) .$$

Next, generate a random number Vₕ|ᵣ˜N(m(r),σ²(r)), which will be the realized portfolio market value.
G. Callable Bonds

The callable bond value equals the “optionless” bond value, less the call option value.

In general, the call provision of a callable bond is the “American” type. (A European call option can only be called at the expiry date, as opposed to the American call option, which can be called at any time.) To price an American call option value usually involves numerical implementation of binomial (trinomial) tree methods or finite different methods, etc. The implementation of these methods is computationally too intense and is not feasible in the VaR framework. We therefore make approximations to simplify the problem and keep the implementation feasible. In doing so, some error will be introduced in estimating the correct value of a callable bond.

Our approximation in our implementation is to replace the value of American option by the maximum value of a series of European options sampling the expiry dates in the callable period. We will assume the well-known Hull and White one-factor interest rate model in pricing the European bond options. This model has the advantage of a closed form solution for the European coupon-bearing bond option and lends itself to easy implementation. It also has the desirable feature of mean reversion. The model is the extended Vasicek's model on short-term risk-free rate r with constant mean version speed a and constant instantaneous short rate volatility σ. The short rate, r, at time t is the rate that applies to an infinitesimally short period of time at time t.
dr=(θ(t)−ar)dt+σdz

θ(t) is a function of time chosen to ensure that the model fits the initial interest rate term structure, and it is analytically calculated in this model. Details regarding θ(t) are irrelevant here. Both a and σ are parameters and are calibrated with market values of capitalization. We will assume that a and σ would not change in the present model's horizon time h. As a and σ reflect market views of expectation of future short rate and future volatility, the assumption may not be valid especially if horizon is as long as that in the present model's framework, which is one year. The proper way of handling changing market views in one year time is to build a model to predict the changes in a and σ. In the present method, a and Cr will be constants that fit current market values of capitalization, set at 0.05 and 0.015, respectively.

G1. Risk Free Zero Coupon Callable Bonds

In the Hull and White, one-factor-interest-rate model, zero-coupon bond prices at time t that matures at time T. P(t, T, r(t)), are given by
P(t, T, r(t))=A(t,T)e^{-B(t,T)r(t)}

$$\begin{matrix}B ( t , T ) = \frac{1 - {ⅇ}^{- a ( T - t )}}{a} \\ ln A ( t , T ) = ln ( \frac{P ( h , T )}{P ( h , t )} ) - B ( t , T ) \frac{\partial ln P ( h , t )}{\partial t} - \\ \frac{1}{4 {a}^{3}} {{σ}^{2} ( {ⅇ}^{- a ( T - h )} - {ⅇ}^{- a ( t - h )} )}^{2} ( {ⅇ}^{2 a ( t - h )} - 1 )\end{matrix}$$

The above equations define the price of a zero-coupon bond at a future time t in terms of the short rate r and the prices of bonds at the time horizon h. The latter will be calculated from simulated interest rate term structure at the horizon. The partial derivative ∂ ln P(h,t)/∂t can be approximated by

$$\frac{\partial ln P ( h , t )}{\partial t} = \frac{ln P ( h , t + ɛ ) - ln P ( h , t - ɛ )}{2 ɛ}$$

where ε is a small length of time such as 0.01 years. When t=h, the partial derivative is

$$\frac{\partial ln P ( h , t )}{\partial t} {\vert}_{t = h} = - r ( h ) .$$

The price at time h of a European call option that matures at time T on a zero-coupon bond maturing at time s is
LP(h,s)N(d)−XP(h,T)N(d−σₚ)
where L is the face value of the bond, X is its strike price and N(•) is the usual cumulative normal distribution function,

$$\begin{matrix}d = \frac{1}{{σ}_{P}} ln ( \frac{LP ( h , s )}{XP ( h , T )} ) + \frac{{σ}_{P}}{2} \\ and \\ {σ}_{P} = \frac{σ}{a} [ 1 - {ⅇ}^{- a ( s - T )} ] \sqrt{\frac{1 - {ⅇ}^{- 2 a ( T - h )}}{2 a}} .\end{matrix}$$

G2. Risk Free Coupon Bearing Callable Bonds

The coupon-bearing bond price can be represented by a weighted sum of zero-coupon bond prices. Suppose that the coupon-bearing bond at time T provides a total of n cash flows in the future. Let the ith cash flow be cᵢ that occurs at time sᵢ (1≦i≦n; sᵢ>T>h).

$$CP ( T , r ( T ) , {c}_{i} , {s}_{i} ) = {\sum }_{i = 1}^{n} {c}_{i} P ( T , {s}_{i} , r ( T ) )$$

The price of an option on a coupon-bearing bond can be obtained from the prices of options on zero-coupon bonds. Consider a European call option with exercise price X and maturity T on a coupon-bearing bond. Suppose that the coupon-bearing bond provides a total of n cash flows after the option matures, just as the one presented above. Define:
r*: value of the short rate r at time T that causes the coupon-bearing bond price to equal the strike price, and
Xᵢ: value at time T of zero-coupon bond paying $1 at time sᵢ when r=r*.
In other words, r* satisfies the equation

$$CP ( T , {r}^{*} , {c}_{i} , {s}_{i} ) = {\sum }_{i = 1}^{n} {c}_{i} P ( T , {s}_{i} , {r}^{*} ) = {\sum }_{i = 1}^{n} {c}_{i} A ( T , {s}_{i} ) {ⅇ}^{- B ( T , {s}_{i} ) {r}^{*}} = X .$$

r* can be obtained very quickly using an iterative procedure such as the Newton-Raphson method, which is well known to those skilled in the art of mathematical calculation techniques.

Given r* is calculated, Xᵢ can be obtained by
Xᵢ=A(T,sᵢ)e^{-B(T,s}^{ᵢ}^{)r*}
and

$$X = {\sum }_{i = 1}^{n} {c}_{i} {X}_{i} .$$

The payoff from the option at time T is

$$max [ 0 , {\sum }_{i = 1}^{n} {c}_{i} P ( T , {s}_{i} , r ( T ) ) - X ]$$

and it can be shown that in the one-factor model, the payoff can be rewritten as

$${\sum }_{i = 1}^{n} {c}_{i} max [ 0 , P ( T , {s}_{i} , r ( T ) ) - {X}_{i} ]$$

which is the sum of n European options on zero-coupon bond with face value $1. Therefore, the price of the European call option is

$${\sum }_{i = 1}^{n} {c}_{i} ( P ( h , {s}_{i} ) N ( {d}_{i} ) - {X}_{i} P ( h , T ) N ( {d}_{i} - {σ}_{{P}_{i}} ) )$$

$$where$$

$$\begin{matrix}{σ}_{{P}_{i}} = \frac{σ}{a} [ 1 - {ⅇ}^{- a ( {s}_{i} - T )} ] \sqrt{\frac{1 - {ⅇ}^{- 2 a ( T - h )}}{2 a}} \\ and \\ {d}_{i} = \frac{1}{{σ}_{{P}_{i}}} ln ( \frac{P ( h , {s}_{i} )}{{X}_{i} P ( h , T )} ) + \frac{{σ}_{{P}_{i}}}{2} .\end{matrix}$$

G3. Risky Callable Bonds

We follow CreditMetrics methodology in evaluating risky callable bonds. At the horizon, rated bonds may end up in a higher rating or a lower rating, or even in default, all of which reflect credit migration probability.

Assume that at the time horizon h, the rating of the bond is AA. The credit spread of AA rating, along with the risk-free interest rate, will be used to discount future cash flow of the bond to evaluate its fair bond price. If it is also callable, the call option value on risky bonds will be estimated by a method similar to that used in risk-free bonds and then subtracted from the “optionless” bond price to obtain the fair bond price.

The only difference between risk-free zero-coupon bond prices and risky zero-coupon bond prices is the credit spread factor. Suppose the risk-free zero-coupon bond price at time t that matures at time T is P(t, T, r(t)) and the forward credit spread is Δₛ(t,T), then risky zero-coupon bond price P_{R}(t, T, r(t)) will be
P_{R}(t, T, r(t))=P(t, T, r(t))·e^{-Δ}^{ₛ}^{(t,T)·(T-t)}

We know that in the Hull-White one-factor-interest-rate model, the distribution of zero-coupon bond prices at any time conditioned by its price at an earlier time is log-normal. It is easy to see that log P_{R} and log P have same volatility. The difference between P_{R} and P comes from their difference in drift terms.

We use a “forward-neutral measure,” under which prices forwarded to time T are “martingales” (i.e., driftless), in order to compute the value of a European call option that matures at time T on a risky zero-coupon bond maturing at time s. The appropriate volatility will be the volatility of the forward bond price, i.e. the volatility of P_{R}(h,s)/P_{R}(h,T) which is same as volatility of P(h,s)/P(h,T). Therefore we can apply Black's formula for the value of the call option struck at X:

$$P ( h , T ) ( L \frac{{P}_{R} ( h , s )}{{P}_{R} ( h , T )} N ( {d}_{R} ) - XN ( {d}_{R} - {σ}_{P} ) ) .$$

Here L is the face value of the bond,

$${d}_{R} = \frac{1}{{σ}_{P}} ln ( \frac{{LP}_{R} ( h , s )}{{XP}_{R} ( h , T )} ) + \frac{{σ}_{P}}{2}$$

and σ_{P} is same as that for risk-free bonds, as expected.

Following the same argument as that in risk-free, coupon-bearing bond, the price of a European option on a risky coupon-bearing bond is:

$${\sum }_{i = 1}^{n} {c}_{i} P ( h , T ) ( \frac{{P}_{R} ( h , {s}_{i} )}{{P}_{R} ( h , T )} N ( {d}_{i}^{R} ) - {X}_{i}^{R} N ( {d}_{i}^{R} - {σ}_{{P}_{i}} ) )$$

where after r* is determined by

$${CP}_{R} ( T , {r}^{*} , {c}_{i} , {s}_{i} ) = {\sum }_{i = 1}^{n} {c}_{i} {P}_{R} ( T , {s}_{i} , {r}^{*} ) = {\sum }_{i = 1}^{n} {c}_{i} A ( T , {s}_{i} ) \cdot {ⅇ}^{- B ( T , {s}_{i} ) {r}^{*}} {ⅇ}^{- {Δ}_{s} ( T , {s}_{i} ) - ( {s}_{i} - T )} = X .$$

Then Xᵢ^{R} can be obtained by
Xᵢ^{R}=A(T,sᵢ)·e^{-B(T,s}^{ᵢ}^{)r*}e^{-Δ}^{ₛ}^{(T,s}^{ᵢ}^{)·(s}^{ᵢ}^{-T)}.
σ_{P}_{ᵢ} is still same as that in risk free bond but

$${d}_{i}^{R} = \frac{1}{{σ}_{{P}_{i}}} ln ( \frac{{P}_{R} ( h , {s}_{i} )}{{X}_{i}^{R} {P}_{R} ( h , T )} ) + \frac{{σ}_{{P}_{i}}}{2}$$

and
P_{R}(h,sᵢ)=P(h,sᵢ)·e^{-Δ}^{ₛ}^{(h,s}^{ᵢ}^{)·(s}^{ᵢ}^{-h)}.
G4. Implementation of Callable Bonds

For a risk-free callable bond, the first call date of the bond is denoted as fcd. If fcd>h, the model picks five points in time between fcd and maturity, including fcd but excluding maturity. Let them be T₁=fcd, T₂, T₃, T₄, T₅<maturity. The model then calculates the European call option values with these five expiry dates and picks the maximum value to be the value of the call provision. The bond price is set equal to the optionless bond price, less the call option value.

If h≦fcd, the optionless bond price is compared with the call price. If call price>optionless bond price, the bond price is set equal to the call price. Otherwise, the model follows step above for the risk-free callable bond but replaces fcd by h.

For a callable risky bond, for every rating except “default,” at the horizon h, the present model follows steps of risk-free callable bond section.

H. Brownian Bridge Method

In our calculation of swap and floating rate security, quasi-Monte Carlo scenario generation of monthly 3-month LIBOR, 6-month LIBOR, 3-month US Treasury rate and 6-month Treasury rate (reference rates) for a one year period of time are required to estimate the value of the floating leg. The existing quasi-Monte Carlo engine can generate the rates at the one year horizon. If we assume that the rates follow Brownian motion and the current rates and rates at the horizon are known, we can use the Brownian bridge method described below to simulate rates on months in between these two dates, provided that the correlation matrix of the rates is known.

Let ρᵢⱼ be the correlation matrix and σᵢ be the monthly volatilities of the rates in consideration. Assume that the current rates and rates at the horizon are r₀ⁱ and rₕⁱ, respectively. Let r_{τ}ⁱ be the rate at month τ, 1≦τ≦h−1. The conditional moments of r_{τ}ⁱ are given by:

$$\begin{matrix}E [ {r}_{τ}^{i} ] = \frac{h - τ}{h} {r}_{0}^{i} + \frac{τ}{h} {r}_{h}^{i} \\ Var [ {r}_{τ}^{i} ] = {σ}_{i}^{2} τ \frac{h - τ}{h}\end{matrix} .$$

Cov(r_{τ}ⁱ,r_{τ}^{j})=ρᵢⱼσᵢσⱼτ

In order to simulate the Brownian bridge process for r_{τ}ⁱ, we employ the following algorithm:
(i) Generate independent, multi-normal distributed random variables u_{τ}ⁱ for each period τ. u_{τ}˜N(0,Σᵢⱼ=ρᵢⱼσᵢσⱼ);
(ii) For all months in between, set

$${r}_{τ}^{i} = \frac{h - τ}{h} {r}_{0}^{i} + \frac{τ}{h} {r}_{h}^{i} + {\sum }_{l = 1}^{τ} {u}_{l}^{i} - \frac{τ}{h} {\sum }_{i = 1}^{h - 1} {u}_{l}^{i} .$$

I. Floating Rate Security

A floating rate security or simply a “floater” is a debt security having a coupon rate that is reset at designated dates based on the value of some designated reference rate. The coupon formula for a pure floater (i.e. without embedded options) can be expressed as follows: the coupon rate equals the reference rate plus or minus the quoted margin. The quoted margin is the adjustment that the issuer agrees to make to the reference rate.

Example of terms for a floater:

| | |
|---|---|
| Maturity date: | Jan. 24, 2005 |
| Reference rate: | 6-month LIBOR |
| Quoted margin: | +30 basis points |
| Reset dates: | Every six months on July 24, January 24 |
| LIBOR determination: | Determined in advance, paid in arrears |

This floater delivers cash flows semi-annually and has a coupon formula equal to 6-month LIBOR plus 30 basis points. The most common reference rates are 6-month LIBOR, 3-month LIBOR, US Treasury bills rate, Prime rate, one-month commercial paper rate.

Suppose we know the appropriate yield curve to discount the future cash flow and we denote it by rᵢ. Immediately after a payment date, the value of the bond, B_{fl}, is equal to its notional amount, Q, if there is no default risk and the credit spread does not change. Between payment dates, we can use the fact that B_{fl} will equal Q immediately after the next payment date. Let us denoted the time to until the next payment date is t₁
B_{fl}=(Q+k*)e^{-r}_{ᵢ}^{t}_{ₗ}
where k* is the floating rate payment (already known) that will be made at time tᵢ.
J. Interest Rate Swap

An interest rate swap involves two parties. One party, B, agrees to pay to the other party, A, cash flows equal to the interest at a predetermined fixed rate on a notional principal for a number of years. At the same time, party A agrees to pay party B cash flows equal to the interest at a floating rate on the same notional principal for the same period of time. The currencies of the two sets of interest cash flows are the same.

Example of terms for an interest rate swap:

| | |
|---|---|
| Trade date: | Jan. 24, 1995 |
| Maturity date: | Jan. 24, 2005 |
| Notional principal: | US $10 million |
| Fixed-rate payer: | Bank |
| Fixed rate: | 6.5% |
| Fixed-rate receiver: | insurance company |
| Reference rate: | 6-month LIBOR |
| Quoted margin: | +30 basis points |
| Reset dates: | Every six months on July 24, January 24 |
| LIBOR determination: | Determined in advance, paid in arrears |

If we assume no possibility of default, an interest rate swap can be valued either as a long position in one bond combined with a short position in another bond. In the above example, the insurance company sells a US $10 million floating-rate bond to the bank and purchases a US $10 million fixed-rate (6.5% per annum) bond from the bank.

Suppose that it is now time h, the horizon, and that under the terms of a swap, the insurance company receives a fixed payment of C dollars at time tᵢ (h≦tᵢ; 1≦i≦n) and makes floating payments at the same time. We define:

V: value of swap to insurance company,

B_{fix}: value of fixed-rate bond underlying the swap,

B_{fl}: value of floating-rate bond underlying the swap, and

Q: notional principal in swap agreement.

It follows that:
V=B_{fix}−B_{fl}.

Let's denote rᵢ as the risk-free interest rates and 66 ᵢ^{j} (j=1, 2) as the credit spread for an insurance company (j=1) and the bank (j=2), corresponding to maturity tᵢ. Since B_{fix} is the value of a bond that pays C dollars at time tᵢ (h≦tᵢ;1≦i≦n) and the principal amount of Q at time tₙ,

$${B}_{fix} = {\sum }_{i = 1}^{n} C {ⅇ}^{- ( {r}_{i} + {Δ}_{i}^{2} ) {t}_{i}} + Q {ⅇ}^{- ( {r}_{n} + {Δ}_{n}^{2} ) {t}_{n}}$$

and
B_{fl}=(Q+C*)e^{-(r}_{ₗ}^{+Δ}^{₁}_{₁})^{t}_{ᵢ}
wherein C* is the floating rate payment (already known) that will be made at time t₁, the time until the next payment date.
K. Currency Swap

The simplest currency swap involves exchanging principal and fixed-rate interest payments on a loan in one currency for principal and fixed-rate interest payments on an approximately equivalent loan in another currency. An example of terms for a currency swap,

| | |
|---|---|
| Trade date: | Jan. 24, 2001 |
| Maturity date: | Jan. 24, 2010 |
| Notional principal 1: | US $10 million |
| Fixed rate 1: | 5.5% |
| Party 1 (receive US): | Insurance company |
| Notional principal 2: | Euro 12 million |
| Fixed rate 2: | 6.5% |
| Party 2 (receive Euro): | Bank |

In the absence of default risk, a currency swap can be decomposed into a position in two bonds in a manner similar to that of an interest rate swap. In general, if V is the value of the swap such as the one above to the insurance company,
V=B_{D}−FX·B_{F}
wherein B_{F} is the value, measured in the foreign currency, of the foreign-denominated bond underlying the swap, B_{D} is the value of the US dollar bond underlying the swap, and FX is the spot exchange rate (express as number of units of domestic currency per unit of foreign currency).

Another popular swap is an agreement to exchange a fixed interest rate in one currency for a floating interest rate in another currency. The value of the swap has the same expression as the formula given for a currency swap. Instead of a fixed-rate bond value, one just replaces it with the floating-rate bond value for the floating leg.

L1. Insurance Risk Property and Casualty Company

Insurance risk is the uncertainty in reserve development in the future. In the present enterprise risk model, distribution of the net worth of an insurance company is calculated at the one-year horizon. Net worth (or surplus) is defined as:
Net worth=Total asset−Reserve−Loans

The uncertainty in reserve contributes to the total risk of the company through the above equation. Based on the current reserve for the future liability (by business line), reserve distribution in one year's time is estimated and integrated with other risks to obtain the total risk of the company.

In the required schedule P of the annual statement of a property and casualty company, there are two triangles: (1) total reserve development (paid loss and future liability, in schedule P part 2) and (2) payout pattern (paid loss, in schedule P part 3). The total reserve does not include “Adjusting and Other Payments (AAO)” and total payout does not include “Adjusting and Other Unpaid.” As “Adjusting and Other Payments” and “Adjusting and Other Unpaid” are like fixed costs (overhead), that is, they behave like constants and are not volatile. We are interested in estimating the volatility of the reserve for future liability and neglecting these two numbers would not introduce significant error. From these two triangles, we can construct two new triangles: (1) current reserve of future liability and (2) last period paid loss+current reserve of future liability.

Denote total reserve by R_{i,j} and cumulative paid loss by CL_{i,j}. The first index indicates the year in which the policy was underwritten and the second index represents the reported year. Both indices are in relative terms, always referring to the latest year in the triangle, so the indices run from −10 to 0, where 0 corresponds to the latest year.

| | Total reserve | | | | | | | | | |
|---|---|---|---|---|---|---|---|---|---|---|
| Years | 1992 | 1993 | 1994 | 1995 | 1996 | 1997 | 1998 | 1999 | 2000 | 2001 |
| Prior | R_{-10,-9} | R_{-10,-8} | . . . | | | | | | R_{-10,-1} | R_{-10,0} |
| 1992 | R_{-9,-9} | R_{-9,-8} | | | | | | | | R_{-9,0} |
| 1993 | xxx | R_{-8,-8} | | | | | | | | |
| 1994 | xxx | xxx | R_{-7,-7} | | | | | | | |
| 1995 | xxx | xxx | xxx | R_{-6,-6} | | | | | | . |
| 1996 | xxx | xxx | xxx | xxx | R_{-5,-5} | | | | | . |
| 1997 | xxx | xxx | xxx | xxx | xxx | R_{-4,-4} | | | | . |
| 1998 | xxx | xxx | xxx | xxx | xxx | xxx | R_{-3,-3} | | | |
| 1999 | xxx | xxx | xxx | xxx | xxx | xxx | xxx | R_{-2,-2} | | |
| 2000 | xxx | xxx | xxx | xxx | xxx | xxx | xxx | xxx | R_{-1,-1} | R_{-1,0} |
| 2001 | xxx | xxx | xxx | xxx | xxx | xxx | xxx | xxx | xxx | R_{0,0} |

| | Cumulative Paid Losses | | | | | | | | | |
|---|---|---|---|---|---|---|---|---|---|---|
| Years | 1992 | 1993 | 1994 | 1995 | 1996 | 1997 | 1998 | 1999 | 2000 | 2001 |
| Prior | CL_{-10,-9} | CL_{-10,-8} | . . . | | | | | | CL_{-10,-1} | CL_{-10,0} |
| 1992 | CL_{-9,-9} | CL_{-9,-8} | | | | | | | | CL_{-9,0} |
| 1993 | xxx | CL_{-8,-8} | | | | | | | | |
| 1994 | xxx | xxx | CL_{-7,-7} | | | | | | | |
| 1995 | xxx | xxx | xxx | CL_{-6,-6} | | | | | | . |
| 1996 | xxx | xxx | xxx | xxx | CL_{-5,-5} | | | | | . |
| 1997 | xxx | xxx | xxx | xxx | xxx | CL_{-4,-4} | | | | . |
| 1998 | xxx | xxx | xxx | xxx | xxx | xxx | CL_{-3,-3} | | | |
| 1999 | xxx | xxx | xxx | xxx | xxx | xxx | xxx | CL_{-2,-2} | | |
| 2000 | xxx | xxx | xxx | xxx | xxx | xxx | xxx | xxx | CL_{-1,-1} | CL_{-1,0} |
| 2001 | xxx | xxx | xxx | xxx | xxx | xxx | xxx | xxx | xxx | CL_{0,0} |

Let's denote current reserve of future liability by RL_{i,j} and last period paid loss+current reserve of future liability by \overline{RL}_{i,j}. Then,
RL_{i,j}=CL_{i,j}−R_{i,j}
and
\overline{RL}_{i,j}=CL_{i,j-1}−R_{i,j}.

The explanation for the unusual definitions of RL_{i,j} and \overline{RL}_{i,j} is as follows. In schedule P, both CL_{i,j} and R_{i,j} are reported as positive numbers. In the present enterprise risk model, liability is negative and so the unusual definitions of RL_{i,j} and \overline{RL}_{i,j} follow accordingly.

What we are interested in is how RL_{i,j} evolves into \overline{RL}_{i,j+1}. We assume that ln(\overline{RL}_{i,j+1}/RL_{i,j}) is normally distributed with volatility σⱼ₋ᵢ. As j−i is the age of the policy, we implicitly assume that there is an aging effect. We also assume that the random variables ln(\overline{RL}_{i,j+1}/RL_{i,j}) are independent of each other as well as of other risk factors. σⱼ₋ᵢ is easily calculated by taking standard deviation of ln(\overline{RL}_{i,j+1}/RL_{i,j}) with constant j−i . For j−i greater than 5, we may not have enough data to estimate σⱼ₋ᵢ with sufficient accuracy. For property and casualty insurance, liability duration is usually not very long, always less than 5. It is safe, however, to make the assumption that σⱼ₋ᵢ is independent of j−i if j−i>5. The error introduced should be small because the relative weight of future liability is dominated by j−i≦5. With this assumption, we can calculate σⱼ₋ᵢ with j−i>5 by taking the standard deviation of ln(\overline{RL}_{i,j+1}/RL_{i,j}) with j−i>5.

The sum of total reserve for future liability at the one year horizon and paid loss in the period from present to the horizon can then be estimated by the following equations:
RL_{i,1}=RL_{i,0}·e^{z}^{ᵢ} −10≦i≦0
where zᵢ are independent, normal, random variables with volatility σ₋ᵢ. The next step is to map RL_{i,1} into cash flow in the future. In order to do that, we need to extract information from the cumulative paid loss (the payout pattern). We want to construct a payout pattern ratio for every business line and then use the payout pattern ratio to map RL_{i,1} into cash flow. We will use part of the cumulative paid loss triangle to construct the payout pattern, i.e., CL_{i,j} with −9≦i≦0 and −9≦j≦0. Let's define L_{i,j} as the paid loss from period j−1 to period j and L′_{i,k} as paid loss in the k years after the policy been underwritten:

$${L}_{i , j} = \{ \begin{matrix}{CL}_{i , j} - {CL}_{i , j - 1} & j > i \\ {CL}_{i , j} & j = i\end{matrix}$$

and
L′_{i,k}=L_{i,i+k} 0≦k≦−i.

Hence we have a triangle like this:

| | Paid Loss | | | | | | | | | |
|---|---|---|---|---|---|---|---|---|---|---|
| Year | Year 0 | Year 1 | Year 2 | Year 3 | Year 4 | Year 5 | Year 6 | Year 7 | Year 8 | Year 9 |
| 1992 | L′_{-9,0} | L′_{-9,1} | . . . | | | | | | L′_{-9,8} | L′_{-9,9} |
| 1993 | | | | | | | | | L′_{-8,8} | xxx |
| 1994 | | | | | | | | L′_{-7,7} | xxx | xxx |
| 1995 | . | | | | | | L′_{-6,6} | xxx | xxx | xxx |
| 1996 | . | | | | | L′_{-5,5} | xxx | xxx | xxx | xxx |
| 1997 | . | | | | L′_{-4,4} | xxx | xxx | xxx | xxx | xxx |
| 1998 | | | | L′_{-3,3} | xxx | xxx | xxx | xxx | xxx | xxx |
| 1999 | | | L′_{-2,2} | xxx | xxx | xxx | xxx | xxx | xxx | xxx |
| 2000 | L′_{-1,0} | L′_{-1,1} | xxx | xxx | xxx | xxx | xxx | xxx | xxx | xxx |
| 2001 | L′_{-0,0} | xxx | xxx | xxx | xxx | xxx | xxx | xxx | xxx | xxx |

First we want to extend the payout to year 14 and assume there is no more liability after year 14.

Let's start with the longest time series, L′_{-9,0} . . . L′_{-9,9}. We would like to extrapolate the time series up to L′_{-9,14}. As RL_{-9,0} is the reserve for future liability, it should be equal to the sum of L′_{-9,10} . . . L′_{-9,14}. If we make the simple assumption that RL_{-9,0} is distributed evenly for the last five years, i.e. from year 10 to year 14, then:

$${L}_{- 9 , k}^{′} = \frac{1}{5} {RL}_{- 9 , 0} \qquad 14 \geq k \geq 10.$$

With extension, we can calculate the ratio X_{-9,k} as defined by

$${x}_{- 9 , k} = \frac{{L}_{- 9 , k}^{′}}{{R}_{- 9 , 0}} \qquad 14 \geq k \geq 10 ,$$

and use this ratio to extend the next time series
L′_{-8,k}=x_{-9,k}·R_{-8,0} 14≧k≧10

$${L}_{- 8 , 9}^{′} = {RL}_{- 8 , 0} - {\sum }_{k = 10}^{14} {L}_{- 9 , k}^{′} .$$

Then sum up this two time series, i.e.
SL_{-8,k}=L′_{-8,k}+L′_{-9,k} 14≧k≧1,
and define the ratio

$${x}_{- 8 , k} = \frac{{SL}_{- 8 , k}}{{R}_{- 8 , 0} + {R}_{- 9 , 0}} \qquad 14 \geq k \geq 1.$$

Please notice that
x_{-8,k}=x_{-9,k} 14≧k≧10.
With the new ratio x_{-8,k}, we can extend the time series L′_{-7,0} . . . L′_{-7,7}:
L′_{-7,k}=x_{-8,k}·R_{-7,0} 14≧k≧9

$${L}_{- 7 , 8}^{′} = {RL}_{- 7 , 0} - {\sum }_{k = 9}^{14} {L}_{- 8 , k}^{′} .$$

and define new time series SL_{-7,k} and new ratio x_{-7,k}:
SL_{-7,k}=L′_{-7,k}+SL_{-8,k} 14≧k≧1

$${x}_{- 7 , k} = \frac{{SL}_{- 7 , k}}{{\sum }_{i = 7}^{9} {R}_{- i , 0}} \qquad 14 \geq k \geq 1.$$

Similarly,
x_{-7,k}=x_{-8,k} 14≧k≧9.

We then repeat the same process until we have the series x_{0,k}. x_{0,k} can then be used to map out the payout pattern for a given RL_{i,1}. We will denote x_{0,k} as xₖ for notational simplicity.

The implementation of Insurance Risk−Reserve Development Risk proceeds as follows. xₖ and σ₋ᵢ will be calculated independently and stored in the data base for future use. Index k runs from 1 to 14 and index i runs from −10 to 0. RL_{i,0}=CL_{i,0}−R_{i,0} is calculated and a normal distributed independent random numbers zᵢ with volatility σ₋ᵢ is generated. Next, period reserve of future liability by RL_{i,1}=RL_{i,0}·e^{z}^{ᵢ} is calculated.

For mapping of RL_{i,1} into future payouts, the maximum length of liability in property and casuaty insurance is assumed to be 15 years. Therefore, 15 “buckets” for future payouts are created. Denote the future payout by P_{i,l}. Index i indicates the year in which the policy was underwritten and corresponds to the index in the next period reserve RL_{i,1}. Index l represents the number of year into the future.

Calculate P_{i,l} for l+1−i≦14

$${P}_{i , l} = {RL}_{i , 1} \cdot \frac{{x}_{l + 1 - i}}{( 1 - {\sum }_{r = 1}^{l - i} {x}_{r} )} .$$

Sum up future payout cash flow by bucket:

$${P}_{l} = {\sum }_{i = - 10}^{0} {P}_{i , l} .$$

Sum up future cash flow generated from risk-free bonds and payout by bucket. Map the total cash flow into the present model's standardized cash flow vertices.
L2. Business Risk (Premium Risk)

Business risk that is due to business cycles, i.e., a soft market following a hard market and vice versa, can be captured by the uncertainty in the estimated initial loss ratio by the actuaries the year in which the policy was underwritten. Initial loss ratio is not the one that is reported in schedule P, but there is enough information in schedule P to estimate this loss ratio.

We define Initial Loss Ratio as:
Initial Loss Ratio=R_{i,j}/(Initial Net Prem Earn−Initial Incurred AAO)
Initial Net Prem Earn can be obtained from schedule P part I column 3 while Initial Incurred AAO can be estimated by:
Initial Incurred AAO=Net Total Losses and Loss Expense Incurred−R_{i,0}
Here Net Total Losses and Loss Expense Incurred can be found in schedule P part I column 28. Then, mean and volatility of Initial Loss Ratio can be calculated given 10 years of historical data.

Those skilled in the art of financial analysis will appreciate the many features and advantages that the present invention has and how it can be adapted with minimal changes and substitutions to related analyses and businesses.

1. A method for assessing the risk to the future capital surplus of an enterprise, said method comprising the steps of:
(a) identifying assets and liabilities of an enterprise;
(b) obtaining data regarding changes in the value of said assets and said liabilities;
(c) analyzing said data to determine variables and correlations among said variables that affect the value of said assets and said liabilities;
(d) simulating at least one scenario of said variables based on said correlations; and
(e) calculating the capital surplus of said enterprise based on the value of said assets and said liabilities for said at least one scenario.

2. The method as recited in claim 1, wherein said simulating step includes simulating multiple scenarios, and said method further comprises the step of producing a distribution of said calculated capital surpluses.

3. The method as recited in claim 2, wherein said simulating step uses quasi-Monte Carlo methods for simulating said multiple future value scenarios.

4. The method as recited in claim 1, wherein said enterprise is an insurance company, and said liabilities include insurance policies.

5. The method as recited in claim 4, wherein said insurance policies have cancellation options exercisable by insureds, and wherein said variables include behavior variables related to exercise of said cancellation options by said insureds, and said scenarios include said behavior variables.

6. The method as recited in claim 1, wherein said at least one scenario simulates said variables at a time one year in the future.

7. The method as recited in claim 1, wherein said enterprise has plural operating divisions, and wherein said method further comprises the step of calculating risk adjusted return on capital for each of said plural operating divisions.

8. A method for analyzing an insurance company according to downside risk to the capital surplus of said insurance company, said method comprising the steps of:
(a) identifying assets and liabilities of an enterprise;
(b) obtaining data regarding changes in the value of said assets and said liabilities;
(c) analyzing said data to determine variables and correlations among said variables that affect the value of said assets and said liabilities;
(d) simulating multiple scenarios of said variables based on said correlations; and
(e) calculating the capital surplus of said enterprise based on the value of said assets and said liabilities for said multiple scenarios;
(f) producing a distribution of said calculated capital surplus;
(g) extracting a downside risk from said distribution; and
(h) analyzing said insurance company based said downside risk.

9. The method as recited in claim 8, wherein said extracting step further comprises the steps of:
(a) calculating a variance of said distribution; and
(b) calculating the ratio of capital surplus to said variance to produce said downside risk.

10. The method as recited in claim 8, wherein said downside risk is selected from the group consisting of probability of default, probability of loss of 50% of capital and probability of loss of 25% capital.

11. The method as recited in claim 8, wherein said changes in said values of said assets and said liabilities result from risk selected from the group consisting of currency exchange risk, interest rate risk, credit rating risk, equity value risk, insurance risk, and combinations thereof.

12. The method as recited in claim 8, wherein said liabilities are selected from the group consisting of life insurance, health insurance, property and casualty insurance, annuities, structured settlements, and combinations thereof.

13. The method as recited in claim 8, wherein said assets are selected from the group consisting of asset-based securities, mortgage-based securities, government bonds, municipal bonds, corporate bonds, preferred stocks, common stocks, caps, swaps, futures, mortgages, real estate holdings, loans, reinsurance receivables, long term investments, and combinations thereof.

14. The method as recited in claim 8, wherein said insurance policies have cancellation options exercisable by insureds, and wherein said variables include behavior variables related to exercise of said cancellation options by said insureds, and said scenarios include said behavior variables.

15. A method of assessing the performance of an enterprise, said method comprising the steps of:
(a) identifying assets and liabilities of an enterprise;
(b) obtaining data regarding changes in the value of said assets and said liabilities;
(c) analyzing said data to determine variables and correlations that affect the value of said assets and said liabilities;
(d) simulating multiple scenarios of said variables based on said correlations; and
(e) calculating the capital surplus of said enterprise based on the value of said assets and said liabilities for said multiple scenarios;
(f) producing a distribution of said calculated capital surplus; and
(g) analyzing said distribution.

16. The method as recited in claim 15, wherein said simulating step further comprises the step of generating said multiple scenarios using quasi-Monte Carlo methods.

17. The method as recited in claim 15, wherein said multiple scenarios is at least 1,000 scenarios.

18. The method as recited in claim 15, wherein said enterprise has more than one division, and said method further comprises the step of allocating capital among said more than one division.

19. The method as recited in claim 18, wherein said step of allocating capital among said more than one division allocates said capital to said more than one division based on risk assumed by said more than one division.

20. The method as recited in claim 15, wherein said enterprise has more than one division, and said method further comprises the step of allocating return on capital to said more than one division.

21. The method as recited in claim 20, wherein said return on capital is risk-adjusted prior to allocation to said more than one division.

22. The method as recited in claim 15, wherein said distribution is characterized by a standard deviation, and wherein said analyzing step further comprises the step of calculating the ratio of capital surplus to said standard deviation.

23. A method of evaluating performance of an enterprise having operating divisions, said method comprising the steps of:
(a) identifying an enterprise having plural divisions;
(b) scaling assets and liabilities of each division of said plural divisions by a factor to yield slices of said assets and said liabilities of said each division;
(c) determining incremental contributions in the future to said surplus capital of said enterprise by said slices beginning with a single slice of said first division and proceeding to a first slice of a second division and continuing until said contribution of a last slice of said assets and said liabilities of a last division is determined;
(d) adding said incremental contributions to said surplus capital for said each division from said slices to obtain the contribution in the future of said each division to said surplus capital of said enterprise; and
(e) identifying the risk distribution contribution from said each division from the added incremental contributions of said each division.

24. The method as recited in claim 23, further comprising the steps of
(a) determining surplus capital for said enterprise; and
(b) allocating surplus capital of said enterprise to said each division in accordance with said risk

25. The method as recited in claim 23, wherein said factor is at least 100.

26. The method as recited in claim 23, wherein said determining step further comprises the steps of:
(a) identifying said assets and liabilities of said enterprise;
(b) obtaining data regarding changes in the value of said assets and said liabilities;
(c) analyzing said data to determine variables and correlations that affect the value of said assets and said liabilities; and
(d) simulating multiple scenarios of said variables based on said correlations; and
(e) calculating the capital surplus of said enterprise based on the value of said assets and said liabilities for said multiple scenarios.

27. The method as recited in claim 26, wherein said multiple scenarios are generated using quasi-Monte Carlo methods.
